(19) United States
(12) Patent Application Publication
(10) Pub. No.: US 2025/0113365 A1
(43) Pub. Date: Apr. 3, 2025

(54) METHOD FOR TRANSMITTING/RECEIVING DOWNLINK SHARED CHANNEL AND UPLINK SHARED CHANNEL, AND DEVICE THEREFOR

(71) Applicant: LG ELECTRONICS INC., Seoul (KR)

(72) Inventors: Sunghoon LEE, Seoul (KR); Seunggye HWANG, Seoul (KR); Suckchel YANG, Seoul (KR); Seonwook KIM, Seoul (KR)

(73) Assignee: LG ELECTRONICS INC., Seoul (KR)

(21) Appl. No.: 18/293,587

(22) PCT Filed: Jul. 25, 2022
(86) PCT No.: PCT/KR2022/010899

§ 371 Date: Jan. 30, 2024

(30) Foreign Application Priority Data
Aug. 6, 2021 (KR) 10-2021-0103892

(51) Int. Cl. H04W 72/231; H04L 5/00; H04W 72/1273

(52) U.S. Cl. CPC H04W 72/231; H04L 5/0053; H04W 72/1273

(57) ABSTRACT

The present disclosure provides a method by which a terminal receives a physical downlink shared channel (PDSCH) in a wireless communication system. Particularly, the method comprises: receiving (i) first information related to a plurality of search space set groups (SSSGs) and (ii) second information for minimum applicable scheduling offsets related to the respective plurality of SSSGs; receiving downlink control information (DCI) through a specific SSSG from among the plurality of SSSGs; and receiving the PDSCH on the basis of the DCI, wherein the PDSCH is scheduled on the basis of the minimum applicable scheduling offset related to the specific SSSG.

### TECHNICAL FIELD

The present disclosure relates to a method of transmitting and receiving a downlink shared channel and an uplink shared channel and device therefor, and more particularly, to a method of configuring a minimum applicable scheduling offset for scheduling of a physical downlink shared channel (PDSCH) and/or a physical uplink shared channel (PUSCH) based on each search space (SS) set group and device therefor.

### BACKGROUND

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IoT)).

### SUMMARY

The present disclosure aims to provide a method of transmitting and receiving a downlink shared channel and an uplink shared channel and device therefor

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

In an aspect of the present disclosure, provided herein is a method of receiving a physical downlink shared channel (PDSCH) by a user equipment (UE) in a wireless communication system. The method may include: receiving (i) first information on a plurality of search space set groups (SSSGs) and (ii) second information on minimum applicable scheduling offsets respectively related to the plurality of SSSGs; receiving downlink control information (DCI) in a specific SSSG among the plurality of SSSGs; and receiving the PDSCH based on the DCI. The PDSCH may be scheduled based on a minimum applicable scheduling offset related to the specific SSSG.

In this case, the PDSCH may be scheduled based on a default minimum applicable scheduling offset of the specific SSSG.

Additionally, the plurality of SSSGs may be independently mapped to the minimum applicable scheduling offsets, respectively.

Additionally, based on the DCI indicating SSSG switching, an application timing of the SSSG switching may be determined based on the minimum applicable scheduling offset and an application delay for the SSSG switching.

Additionally, based on the DCI indicating SSSG switching and a change in the minimum applicable scheduling offset, the change in the minimum applicable scheduling offset may be applied based on a larger value of a first application delay based on the minimum applicable scheduling offset and a second application delay for the SSSG switching.

Additionally, based on that bits for the minimum applicable scheduling offset included in the DCI have a specific value, the minimum applicable scheduling offset may not be applied.

In another aspect of the present disclosure, provided herein is a UE configured to receive a PDSCH in a wireless communication system. The UE may include: at least one transceiver; at least one processor; and at least one memory operably connected to the at least one processor and configured to store instructions that, when executed, cause the at least one processor to perform operations. The operations may include: receiving (i) first information on a plurality of SSSGs and (ii) second information on minimum applicable scheduling offsets respectively related to the plurality of SSSGs through the at least one transceiver; receiving DCI in a specific SSSG among the plurality of SSSGs through the at least one transceiver; and receiving the PDSCH based on the DCI through the at least one transceiver. The PDSCH may be scheduled based on a minimum applicable scheduling offset related to the specific SSSG.

In this case, the PDSCH may be scheduled based on a default minimum applicable scheduling offset of the specific SSSG.

Additionally, the plurality of SSSGs may be independently mapped to the minimum applicable scheduling offsets, respectively.

Additionally, based on the DCI indicating SSSG switching, an application timing of the SSSG switching may be determined based on the minimum applicable scheduling offset and an application delay for the SSSG switching.

Additionally, based on the DCI indicating SSSG switching and a change in the minimum applicable scheduling offset, the change in the minimum applicable scheduling offset may be applied based on a larger value of a first application delay based on the minimum applicable scheduling offset and a second application delay for the SSSG switching.

Additionally, based on that bits for the minimum applicable scheduling offset included in the DCI have a specific value, the minimum applicable scheduling offset may not be applied.

In another aspect of the present disclosure, provided herein is an apparatus configured to receive a PDSCH in a wireless communication system. The apparatus may include: at least one processor; and at least one memory operably connected to the at least one processor and configured to store instructions that, when executed, cause the at least one processor to perform operations. The operations may include: receiving (i) first information on a plurality of SSSGs and (ii) second information on minimum applicable scheduling offsets respectively related to the plurality of SSSGs; receiving DCI in a specific SSSG among the plurality of SSSGs; and receiving the PDSCH based on the DCI. The PDSCH may be scheduled based on a minimum applicable scheduling offset related to the specific SSSG.

In another aspect of the present disclosure, provided herein is a computer-readable storage medium including at least one computer program that causes at least one processor to perform operations. The operations may include: receiving (i) first information on a plurality of SSSGs and (ii) second information on minimum applicable scheduling offsets respectively related to the plurality of SSSGs; receiving DCI in a specific SSSG among the plurality of SSSGs; and receiving the PDSCH based on the DCI. The PDSCH may be scheduled based on a minimum applicable scheduling offset related to the specific SSSG.

In another aspect of the present disclosure, provided herein is a method of transmitting a PDSCH by a base station (BS) in a wireless communication system. The method may include: transmitting (i) first information on a plurality of SSSGs and (ii) second information on minimum applicable scheduling offsets respectively related to the plurality of SSSGs; transmitting DCI in a specific SSSG among the plurality of SSSGs; and transmitting the PDSCH based on the DCI. The PDSCH may be scheduled based on a minimum applicable scheduling offset related to the specific SSSG.

In a further aspect of the present disclosure, provided herein is a BS configured to transmit a PDSCH in a wireless communication system. The BS may include: at least one transceiver; at least one processor; and at least one memory operably connected to the at least one processor and configured to store instructions that, when executed, cause the at least one processor to perform operations. The operations may include: transmitting (i) first information on a plurality of SSSGs and (ii) second information on minimum applicable scheduling offsets respectively related to the plurality of SSSGs through the at least one transceiver; transmitting DCI in a specific SSSG among the plurality of SSSGs through the at least one transceiver; and transmitting the PDSCH based on the DCI through the at least one transceiver. The PDSCH may be scheduled based on a minimum applicable scheduling offset related to the specific SSSG.

According to the present disclosure, a user equipment (UE) may be configured with a minimum applicable scheduling offset suitable for the purpose of each search space (SS) set group (SSSG), thereby reducing the transmission latency of a physical downlink shared channel (PDSCH) and/or a physical uplink shared channel (PUSCH) and improving power efficiency.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

FIGS. 1 and 2 are diagrams for explaining idle mode discontinuous reception (DRX) operation;

FIGS. 3 to 5 are diagrams for explaining DRX operation in a radio resource control (RRC) connected mode;

FIG. 6 is a diagram for explaining a method of monitoring DCI format 2_6;

FIG. 7 illustrates a process for transmitting PDSCH (Physical Downlink Shared Channel), a physical uplink control channel (PUCCH) and a physical uplink shared channel (PUSCH).

FIGS. 8 to 13 are diagrams for explaining the overall operation processes of a UE and a BS according to an embodiment of the present disclosure;

FIG. 14 illustrates an exemplary communication system applied to the present disclosure;

FIG. 15 illustrates an exemplary wireless device applicable to the present disclosure;

FIG. 16 illustrates an exemplary vehicle or autonomous driving vehicle applicable to the present disclosure; and

FIG. 17 illustrates an extended reality (XR) device applicable to the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

### DRX (Discontinuous Reception) Operation

The UE uses Discontinuous Reception (DRX) in RRC_IDLE and RRC_INACTIVE state in order to reduce power consumption. When the DRX is configured, the UE performs a DRX operation according to DRX configuration information.

When the UE operates based on the DRX, the UE repeats ON/OFF for reception. For example, when the DRX is configured, the UE attempts to receive/detect the PDCCH (e.g., PDCCH monitoring) only in a predetermined time interval (e.g., ON), and does not attempt to receive the PDCCH in the remaining time period (e.g., OFF/sleep).

At this time, a time period during which the UE should attempt to receive the PDCCH is referred to as an On-duration, and this on-duration is defined once per DRX cycle. The UE can receive DRX configuration information from a gNB through a RRC signaling and operate as the DRX through a reception of the (Long) DRX command MAC CE.

The DRX configuration information may be included in the MAC-CellGroupConfig. The IE MAC-CellGroupConfig is used to configure MAC parameters for a cell group, including DRX.

DRX (Discontinuous Reception) means an operation mode for enabling a UE (User Equipment) to reduce battery consumption so that the UE can receive/monitor a downlink channel discontiguously. That is, a UE configured with DRX can reduce power consumption by receiving a DL signal discontiguously. The DRX operation is performed in a DRX cycle indicative of a time interval in which On Duration is periodically repeated. The DRX cycle includes On Duration and sleep duration (or Opportunity for DRX). The On Duration indicates a time interval in which a UE monitors a PDCCH in order to receive the PDCCH. DRX may be performed in an RRC (Radio Resource Control)_IDLE state (or mode), an RRC_INACTIVE state (or mode), or an RRC_CONNECTED state (or mode). In the RRC_IDLE state and the RRC_INACTIVE state, DRX is used to receive a paging signal discontiguously.
RRC_Idle state: state in which a radio connection (RRC connection) is not established between a base station and a UE.
RRC Inactive state: state in which a radio connection (RRC connection) has been established between a base station and a UE, but a radio connection is inactivated.
RRC_Connected state: state in which a radio connection (RRC connection) has been established between a base station and a UE.

DRX is basically divided into Idle mode DRX, Connected DRX (C-DRX) and extended DRX. DRX applied in the RRC IDLE state is called Idle mode DRX, and DRX applied in the RRC CONNECTED state is called Connected mode DRX (C-DRX).

eDRX (Extended/enhanced DRX) is a mechanism capable of expanding the cycle of Idle mode DRX and C-DRX. In the Idle mode DRX, whether to permit eDRX may be configured based on system information (e.g., SIB1).

The SIB1 may include an eDRX-Allowed parameter. The eDRX-Allowed parameter is a parameter indicating whether Idle mode extended DRX is permitted.

### (1) IDLE Mode DRX

In the IDLE mode, the UE may use DRX to reduce power consumption. One paging occasion (PO) may be a time interval (e.g., a slot or a subframe) in which a paging-radio network temporary identifier (P-RNTI) based physical downlink control channel (PDCCH) may be transmitted. The P-RNTI-based PDCCH may address/schedule a paging message. For P-RNTI-based PDCCH transmission, the PO may indicate a first subframe for PDCCH repetition.

One paging frame (PF) is one radio frame which may include one or a plurality of paging occasions. When DRX is used, a UE may be configured to monitor only one PO per DRX cycle. The PF, PO and/or PNB may be determined based on a DRX parameter provided via network signaling (e.g., system information).

Hereafter, ‘PDCCH’ may refer to MPDCCH, NPDCCH and/or normal PDCCH. Hereafter, ‘UE’ may refer to MTC UE, BL (Bandwidth reduced Low complexity)/CE (coverage enhanced) UE, NB-IoT UE, Reduced Capability (RedCap) UE, normal UE and/or IAB-MT (mobile termination).

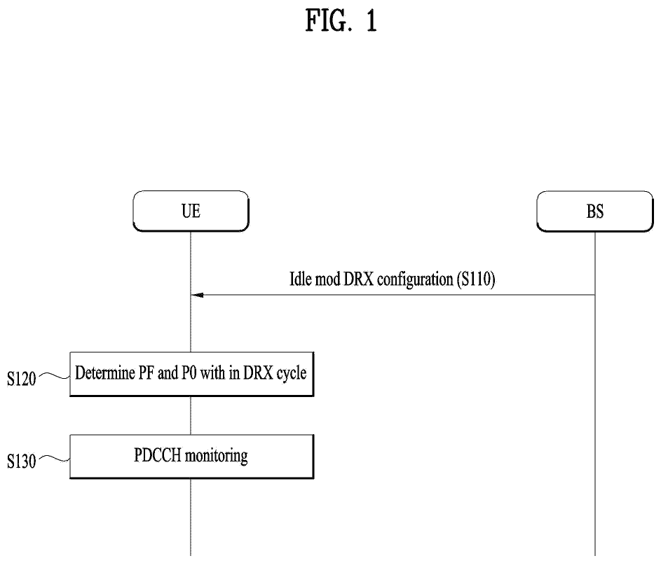

FIG. 1 is a flowchart showing an example of a method of performing an Idle mode DRX operation.

A UE receives, from a base station, Idle mode DRX configuration information through a higher layer signaling (e.g., system information) (S110).

Furthermore, the UE determines a PF (Paging Frame) and a PO (Paging Occasion), for monitoring a physical downlink control channel (e.g., PDCCH) in a paging DRX cycle based on the Idle mode DRX configuration information (S120). In this case, the DRX cycle includes On Duration and sleep duration (or Opportunity for DRX).

Furthermore, the UE monitors a PDCCH in the PO of the determined PF (S130). The UE monitors only one time interval (PO) for each paging DRX cycle. For example, the time interval may be a slot or a subframe.

Additionally, if the UE receives a PDCCH (more exactly, CRC of PDCCH) scrambled by a P-RNTI during On duration (i.e., if paging is detected), the UE may transit to a connected mode and transmit or receive data with the base station.

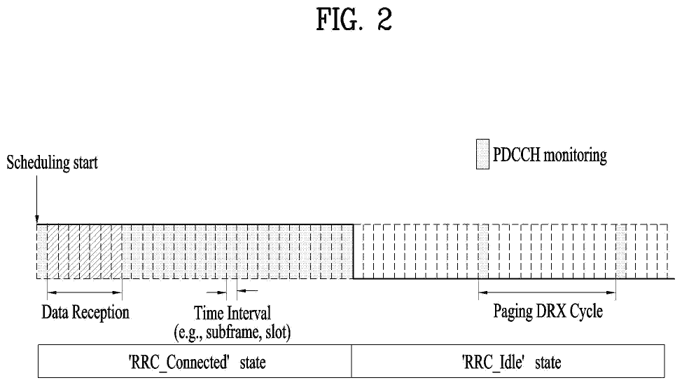

FIG. 2 is a diagram showing an example of an Idle mode DRX operation.

Referring to FIG. 2, if there is a traffic (data) toward a UE in the RRC_Idle state (hereinafter referred to as ‘Idle state’), paging occurs toward the corresponding UE.

Thus, the UE wakes up every (paging) DRX cycle and monitors a PDCCH.

If Paging is present, the UE transits to a Connected state, and receives data. Otherwise, the UE may enter a sleep mode again.

### (2) Connected Mode DRX (C-DRX)

C-DRX is DRX applied in the RRC Connected state. The DRX cycle of C-DRX may be configured with a Short DRX cycle and/or a Long DRX cycle. The Short DRX cycle is Optional.

If C-DRX is configured, a UE performs PDCCH monitoring for On Duration. If there is a PDCCH successfully detected during the PDCCH monitoring, the UE operates (or runs) an inactivity timer and maintains an awake state. In contrast, if there is no PDCCH successfully detected during the PDCCH monitoring, the UE enters to a sleep state after the On Duration is ended.

If C-DRX is configured, a PDCCH reception occasion (e.g., a slot having a PDCCH search space/candidate) may be configured discontiguously based on a C-DRX configuration. In contrast, if C-DRX is not configured, a PDCCH reception occasion (e.g., a slot having a PDCCH search space/candidate) may be configured contiguously in accordance with PDCCH search space configuration. Meanwhile, PDCCH monitoring may be limited in a time interval configured as a measurement gap, regardless of a C-DRX configuration.

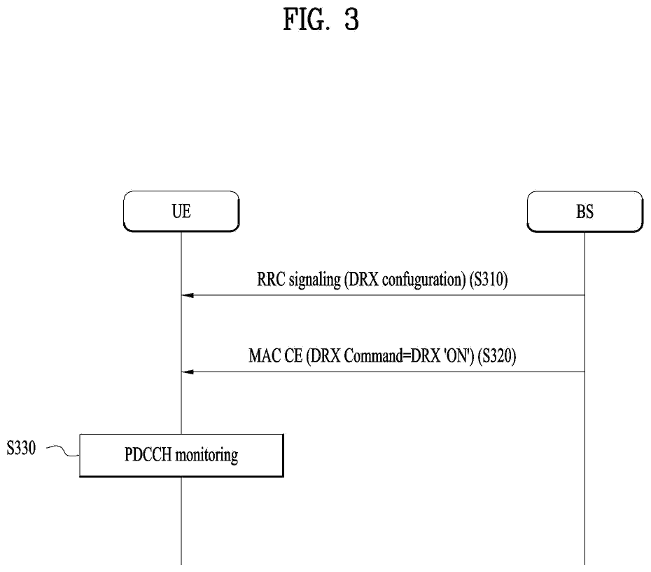

FIG. 3 is a flowchart showing an example of a method of performing a C-DRX operation.

A UE receives, from a base station, RRC signalling (e.g., MAC-MainConfig IE) including DRX configuration information (S310). The DRX configuration information may include the following information.
on-duration: the duration that the UE waits for, after waking up, to receive PDCCHs. If the UE successfully decodes a PDCCH, the UE stays awake and starts the drx-inactivity timer;
onDurationTimer: the duration in which the DRX cycle starts. For example, the duration may refer to a time interval to be continuously monitored at the beginning of a DRX cycle, which may be represented in units of milliseconds (ms).
drx-InactivityTimer: the duration after the PDCCH occasion in which a PDCCH indicates a new UL or DL transmission for the MAC entity. For example, the duration may be a time interval represented in units of ms after the UE decodes the PDCCH including scheduling information. That is, the duration refers to a duration in which the UE waits to successfully decode another PDCCH after decoding the PDCCH. If no other PDCCHs are detected within the corresponding duration, the UE transitions to the sleep mode.

The UE restarts the drx-inactivity timer after successfully decoding a PDCCH for initial transmission only except for a PDCCH for retransmission.
drx-RetransmissionTimer: for DL, the maximum duration until a DL retransmission is received; for UL the maximum duration until a grant for UL retransmission is received. For example, for UL, drx-RetransmissionTimer indicates the number of slots in a bandwidth part (BWP) where a transport block (TB) to be retransmitted is transmitted. For DL, drx-RetransmissionTimer indicates the number of slots in a BWP in which a TB to be retransmitted is received.
longDRX-Cycle: On Duration occurrence period
drxStartOffset: a subframe number in which a DRX cycle is started
drxShortCycleTimer: the duration the UE shall follow the Short DRX cycle;
shortDRX-Cycle: a DRX Cycle operating as much as a drxShortCycleTimer number when Drx-InactivityTimer is terminated
drx-SlotOffset: the delay before drx-onDurationTimer starts. For example, the delay may be expressed in units of ms, and more particularly, in multiples of 1/32 ms.

Active time: total duration that the UE monitors PDCCH, which may include (a) the “on-duration” of the DRX cycle, (b) the time UE is performing continuous reception while the drx-inactivity timer has not expired, and (c) the time when the UE is performing continuous reception while waiting for a retransmission opportunity.

Specifically, when the DRX cycle is configured, an active time for a serving cell of a DRX group includes the following.
(a) drx-onDurationTimer or (b) drx-InactivityTimer configured for the DRX group is running; or
(c) drx-RetransmissionTimerDL or drx-RetransmissionTimerUL is running on any Serving Cell in the DRX group; or
(d) ra-ContentionResolutionTimer or msgB-ResponseWindow is running; or
(e) a Scheduling Request is sent on PUCCH and is pending; or
(f) a PDCCH indicating a new transmission addressed to the C-RNTI of the MAC entity has not been received after successful reception of a Random Access Response for the Random Access Preamble not selected by the MAC entity among the contention-based Random Access Preamble.

Furthermore, if DRX ‘ON’ is configured through the DRX command of a MAC CE (command element) (S320), the UE monitors a PDCCH for the ON duration of a DRX cycle based on the DRX configuration (S330).

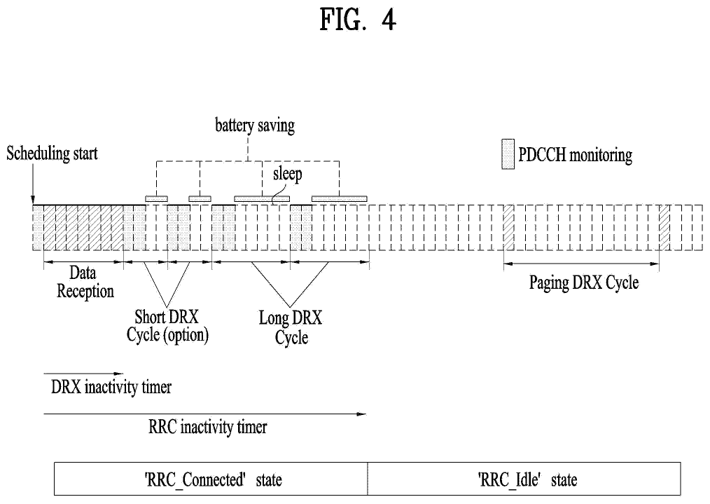

FIG. 4 is a diagram showing an example of a C-DRX operation.

Referring to FIG. 4 when the UE receives scheduling information (e.g., DL assignment or UL grant) in the RRC_Connected state (hereinafter referred to as the connected state), the UE runs a DRX inactivity timer and an RRC inactivity timer.

After the DRX inactivity timer expires, a DRX mode starts. The UE wakes up in a DRX cycle and monitors a PDCCH during a predetermined time (on duration timer).

In this case, if Short DRX is configured, when the UE starts the DRX mode, the UE first starts in a short DRX cycle, and starts to a long DRX cycle after the short DRX cycle is terminated. The Long DRX cycle is a multiple of the short DRX cycle. In the short DRX cycle, the UE wakes up more frequently. After the RRC inactivity timer expires, the UE shifts to an Idle state and performs an Idle mode DRX operation.

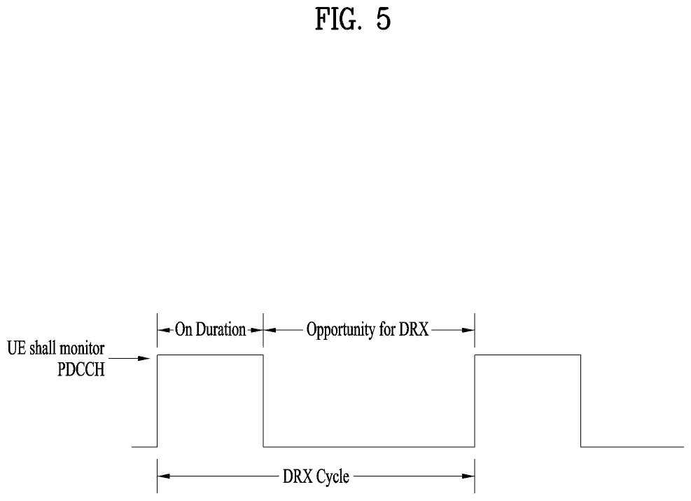

FIG. 5 illustrates a DRX cycle. The C-DRX operation has been introduced for power saving of the UE. If the UE receives no PDCCH within the on-duration defined for each DRX cycle, the UE enters the sleep mode until the next DRX cycle and does not perform transmission/reception.

On the other hand, when the UE receives a PDCCH within the on-duration, the active time may continue (or increase) based on the operations of an inactivity timer, a retransmission timer, etc. If the UE receives no additional data within the active time, the UE may operate in the sleep mode until the next DRX operation.

In NR, a wake-up signal (WUS) has been introduced to obtain additional power saving gain in addition to the existing C-DRX operation. The WUS may be to inform whether the UE needs to perform PDCCH monitoring within the on-duration of each DRX cycle (or a plurality of DRX cycles). If the UE detects no WUS on a specified or indicated WUS occasion, the UE may maintain the sleep mode without performing PDCCH monitoring in one or more DRX cycles associated with the corresponding WUS.

### (3) WUS (DCI Format 2_6)

According to the power saving technology of Rel-16 NR systems, when the DRX operation is performed, it is possible to inform the UE whether the UE needs to wake up for each DRX cycle by DCI format 2_6.

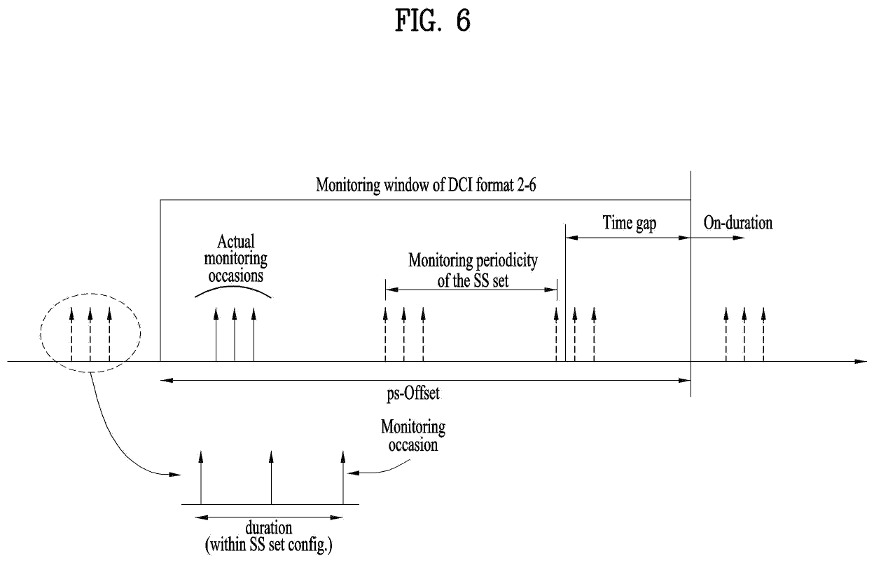

Referring to FIG. 6, a PDCCH monitoring occasion for DCI format 2_6 may be determined by ps-Offset indicated by the network and a time gap reported by the UE. In this case, the time gap reported by the UE may be interpreted as a preparation period necessary for an operation after the UE wakes up.

Referring to FIG. 6, the base station (BS) may provide the UE with a search space (SS) set configuration capable of monitoring DCI format 2_6. According to the corresponding SS set configuration, DCI format 2_6 may be monitored in consecutive slots as long as the duration at the monitoring periodicity interval.

In the DRX configuration, a monitoring window for monitoring DCI format 26 may be determined by the start time of the DRX cycle (e.g., a point where the on-duration timer starts) and ps-Offset configured by the BS. In addition, PDCCH monitoring may not be required in the time gap reported by the UE. Consequently, an SS set monitoring occasion on which the UE actually performs monitoring may be determined as a first full duration (i.e., actual monitoring occasions of FIG. 6) within the monitoring window.

If the UE detects DCI format 2_6 in the monitoring window configured based on ps-Offset, the UE may be informed by the BS whether the UE wakes up in the next DRX cycle.

### Search Space Set (SS Set) Group Switching

In the current NR standards, the SS set group switching has been defined to reduce the power consumption of the UE. According to the SS set group switching, the UE may be configured with a plurality of SS set groups, and an SS set group to be monitored by the UE among the plurality of SS set groups may be indicated. In addition, the UE may monitor an SS set included in the corresponding SS set group according to the corresponding indication and skip monitoring of SS sets not included in the corresponding SS set group.

For example, the UE may be provided with a list of SS set groups configured with a Type 3-PDCCH common search space (CSS) set and/or a user-specific search space (USS) set. In addition, if a list of SS set groups is provided, the UE may monitor SS sets corresponding to group index #0.

The UE may perform the SS set group switching operation depending on whether SearchSpaceSwitchTrigger is configured.

If SearchSpaceSwitchTrigger is configured for the UE, the UE may switch the SS set group according to the indication of DCI format 2_0.

For example, if the value of an SS Set Group Switching Flag field in DCI format 2_0 is 0, the UE may start monitoring SS set group #0 after a predetermined time from the time when the UE receives DCI format 2_0 and stop monitoring SS set group #1.

If the value of the SS Set Group Switching Flag field in DCI format 2_0 is 1, the UE may start monitoring SS set group #1 after a predetermined time from the time when the UE receives DCI format 2_0 and stop monitoring SS set group #0. If the UE starts monitoring SS set group #1, the UE may start counting a timer configured by SearchSpaceSwitchTimer. If the timer expires, the UE may start monitoring SS set group #0 after a predetermined time from the time when the timer expires and stop monitoring SS set group #1.

If SearchSpaceSwitchTrigger is not configured for the UE, the UE may change the SS set group based on DCI reception. For example, when the UE receives the DCI while monitoring SS set group #0 (or SS set group #1), the UE may start monitoring SS set group #1 (or SS set group #0) after a predetermined time from the time when the UE receives the DCI and stop monitoring SS set group #0 (or SS set group #1). In this case, the UE may start counting the timer configured by SearchSpaceSwitchTimer. If the timer expires, the UE may start monitoring SS set group #0 (or SS set group #1) after a predetermined time from the time when the timer expires and stop monitoring SS set group #1 (or SS set group #0).

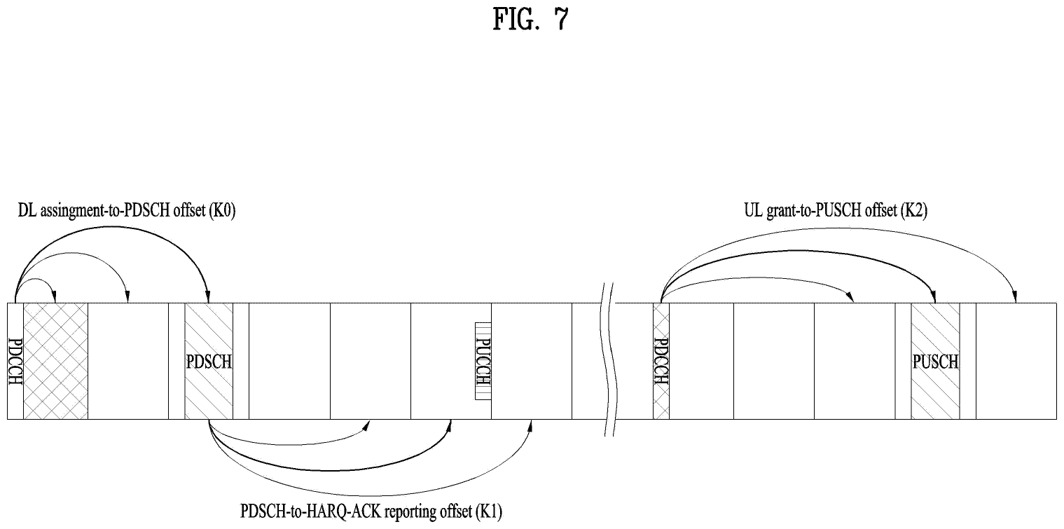

FIG. 7 is a diagram that illustrates timings of transmitting a physical downlink shared channel (PDSCH), a physical uplink control channel (PUCCH), and a physical uplink shared channel (PUSCH) and allocation methods therefor.

In FIG. 7, KG represents the number of slots from a slot with a PDCCH carrying DL assignment (i.e., DL grant) to a slot with corresponding PDSCH transmission, K1 represents the number of slots from a slot with a PDSCH to a slot with corresponding HARQ-ACK transmission, and K2 represents the number of slots from a slot with a PDCCH carrying a UL grant to a slot with corresponding PUSCH transmission. That is, K0, K1, and K2 may be briefly summarized as shown in Table 1 below.

TABLE 1

| | A | B |
|---|---|---|
| K0 | DL scheduling DCI | Corresponding DL data |
| | | transmission |
| K1 | DL data reception | Corresponding HARQ-ACK |
| K2 | UL scheduling DCI | Corresponding UL data |
| | | transmission |

The BS may provide a HARQ-ACK feedback timing to the UE dynamically by DCI or semi-statically by RRC signaling. Referring to FIG. 7, the UE may detect a PDCCH in slot #n. The PDCCH includes DL scheduling information (e.g., DCI format 1_0 and/or DCI format 1_1). The PDCCH indicates a DL assignment-to-PDSCH offset KG and a PDSCH-to-HARQ-ACK reporting offset K1. DCI format 1_0 and DCI format 1_1 may include, for example, the following information.
Frequency domain resource assignment: indicates an RB resource assigned to a PDSCH (e.g. one or more (dis)continuous RBs).
Time domain resource assignment: indicates KG and the starting position (e.g., OFDM symbol index) and length (e.g., the number of OFDM symbols) of a PDSCH in a slot.
PDSCH-to-HARQ_feedback timing indicator: indicates K1.
HARQ process number (4 bits): indicates a HARQ process identity (ID) for data (e.g., a PDSCH or a TB).
PUCCH resource indicator (PRI): indicates a PUCCH resource to be used for UCI transmission among a plurality of PUCCH resources in a PUCCH resource set.

Next, the UE may receive a PDSCH in slot #(n+K0) according to scheduling information of slot #n and then transmit UCI on a PUCCH in slot #(n+K1). The UCI includes a HARQ-ACK response to the PDSCH. In the case in which the PDSCH is configured to carry a maximum of one TB, the HARQ-ACK response may be configured as one bit. In the case in which the PDSCH is configured to carry up to two TBs, the HARQ-ACK response may be configured as two bits if spatial bundling is not configured and as one bit if spatial bundling is configured. When slot #(n+K1) is designated as a HARQ-ACK transmission timing for a plurality of PDSCHs, UCI transmitted in slot #(n+K1) includes HARQ-ACK responses to the plurality of PDSCHs.

Referring to FIG. 7, the UE may detect a PDCCH in slot #n. The PDCCH includes UL scheduling information (e.g., DCI format 0_0 and/or DCI format 0_1). DCI format 0_0 and DCI format 01 may include the following information.
Frequency domain resource assignment: indicates an RB set assigned to a PUSCH.
Time domain resource assignment: indicates a slot offset K2 and the starting position (e.g., symbol index) and length (e.g., the number of OFDM symbols) of a PUSCH in a slot. The starting symbol and length may be indicated by a start and length indicator value (SLIV) or may be indicated individually.

Thereafter, the UE may transmit the PUSCH in slot #(n+k2) according to the scheduling information of slot #n. Here, the PUSCH includes a UL-SCH TB.

### Minimum Applicable Scheduling Offset

When the UE is configured with minimumSchedulingOffsetK0/K2, a change in the minimum scheduling offset restriction (K0min/K2min) may be indicated by the ‘minimum applicable scheduling offset indicator’ field in (PDSCH/PUSCH) scheduling downlink control information (DCI). When the change in the minimum scheduling offset restriction is indicated by the scheduling DCI, the UE may not expect the value of K0/K2 indicated by DCI to be less than Ceil {K0min(2^{u}/2^{u})} or Ceil{K2min(2^{u′}/2^{u})} from the time the change is applied onward. In other words, the value of K0/K2 indicated by the DCI needs to be equal to or greater than Ceil {K0min(2^{u′}/2^{u})} or Ceil{K2min(2^{u′}/2^{u})}, where u′ represents the numerology of a new active BWP when there is a change in the active BWP, and u represents the numerology of the active (DL/UL) BWP of a scheduled cell when the DCI is received.

When the UE is configured with minimumSchedulingOffsetK0/K2, if the UE does not receive the ‘minimum applicable scheduling offset indicator’ field in DCI, the UE may consider that K0min/K2min corresponding to the value ‘0’ in the ‘minimum applicable scheduling offset indicator’ field is indicated.

However, since a search space (SS) set associated with control resource set (CORESET) Type 0 is related to recoverySearchSpaceSetId, K0min is not applied when a PDSCH is scheduled based on a default PDSCH time domain resource allocation table or when the PDSCH is scheduled based on an SI-RNTI, MSGB-RNTI, or RA-RNTI.

In addition, K2min is not applied when a PUSCH is scheduled by a Random Access Response (RAR) UL grant or fallback RAR UL grant or when the PUSCH is scheduled based on a TC-RNTI.

### Application Timing of K0min/K2min

If new K0min/K2min is indicated by DCI, existing K0min/K2min is applied until new K0min/K2min is applied. If both an indication for changes in K0min/K2min and an indication for active BWP switching are received in a single DCI, new K0min/K2min may be applied from a slot corresponding to the K0/K2 values indicated by the DCI.

If an indication for changes in K0min/K2min is received in DCI without an indication for active BWP switching, new K0min/K2min may be applied from slot (n+X). In this case, slot n is a slot where the DCI is received. If the DCI is received within the first three symbols of slot n, X is defined as X=max{Ceil[K0minold (2^{uPDCCH}/2^{uPDSCH})]Zᵤ}, where K0minold is currently applied K0min. If minimumSchedulingOffsetK0 is not configured, K0minold is 0.

In this case, uPDCCH and uPDSCH denote the subcarrier spacing (SCS) for a PDCCH of the active BWP of a scheduling cell and the SCS for a PDSCH of the active BWP of a scheduled cell, respectively, and Zᵤ is determined depending on the SCS of the scheduling cell in slot n as shown in Table 2.

TABLE 2

| μ | Zu |
|---|---|
| 0 | 1 |
| 1 | 1 |
| 2 | 2 |
| 3 | 2 |

If the DCI is received in symbols other than the first three symbols of slot n, the value of Zᵤ according to [Table 2] increases by 1 before X is determined. In other words, if the DCI is received on symbols other than the first three symbols of slot n, X is defined as X=max{Ceil[K0minold (2^{uPDCCH}/2^{uPDSCH})]Zᵤ+1}. This is to allow the time required to decode the DCI by delaying the application time by one slot if the DCI is received in symbols behind the first three symbols. Additionally, when an indication for changes in K0min/K2min is received by DCI without an indication for active BWP switching, if different DCI indicating active BWP switching is received before slot (n+X), new K0min/K2min may be applied from the first slot among slots that does not precede slot (n+X), based on the SCS of the active BWP in slot n.

Meanwhile, embodiments to be described later may be applied to, for example, extended reality (XR). XR is a concept that encompasses augmented reality (AR), virtual reality (VR), and mixed reality (MR). XR is characterized in that a timing when traffic is expected to be received is fixed to frames per second (fps) and traffic may be received later or earlier than the expected timing due to the influence of jitter. This jitter of XR traffic is represented as a truncated Gaussian probability distribution. Therefore, a power saving effect may be expected by cyclically configuring DRX according to fps. Even when DRX is not configured, if PDCCH monitoring adaptation is configured, the power saving effect may be expected only by PDCCH monitoring adaptation. It is apparent that the power saving effect may also be expected by configuring both DRX and PDCCH monitoring adaptation.

An expected traffic reception timing and an expected reception timing which is caused by the effect of jitter may be expressed as a probability, and embodiments to be described later may be applied to achieve the power saving effect in an XR environment as described above.

For example, since a jitter probability is low and thus a traffic reception probability is low at a timing which is relatively distant in time from the expected traffic reception timing, the UE may save power by sparsely monitoring a PDCCH. Conversely, since the jitter probability is high and thus the traffic reception probability is high at a timing which is close in time to the expected traffic reception timing, the UE may adjust power consumption according to the reception probability by densely monitoring the PDCCH. For this purpose, SS set group #0 may be configured as an SS set group including an SS set for dense PDCCH monitoring, and SS set group #1 may be configured as an SS set group including an SS set for sparse PDCCH monitoring. In other words, SS set Switching operation may be configured considering jitter in XR. In other words, an SS set switching operation may be configured considering jitter in XR.

As another example, the UE may repeat an operation of performing PDCCH monitoring during a short duration in which the traffic reception probability is high due to a high jitter probability and then entering micro-sleep. Therethrough, when traffic is not normally received, the UE may quickly enter micro-sleep to achieve power saving and then perform PDCCH monitoring to receive retransmitted traffic, thereby increasing the efficiency of PDCCH monitoring. In other words, a PDCCH monitoring skipping operation may be configured considering jitter in XR.

While the present disclosure proposes an operation through DCI reception within a DRX active time as an example, an operation of the same scheme may be applied to a UE for which DRX is not configured.

The present disclosure proposes methods of applying the minimum scheduling offset restriction (for example, K0min or K2min) differently depending on the index of an SS set group (SSSG) monitored by the UE when the UE capable of receiving an SSSG switching indication is capable of being configured with cross-slot scheduling. In addition, UE operations for addressing potential errors that may occur when the UE is configured with both the operations simultaneously are also provided.

Cross-slot scheduling means that the location of a slot in which the UE receives DCI is different from that of a slot in which a PDSCH/PUSCH is scheduled. In other words, cross-slot scheduling may mean that when the UE receives DCI in slot n, resources are allocated such that a PDSCH/PUSCH scheduled by the corresponding DCI is transmitted or received in slot (n+k).

In Rel-15 NR standards, one or more K0/K2 values may be configured through the RRC layer. When a PDSCH/PUSCH is actually scheduled, one of a plurality of K0/K2 values may be determined. For example, the UE may decode DCI, check the value of K0/K2 value indicated by the DCI among a plurality of K0/K2 values, and determine time resources (timer-domain resource) of an actually scheduled PDSCH/PUSCH. Therefore, if one or more K0/K2 values configured to the UE through the RRC layer are all greater than 0, it may be considered that the UE is always scheduled with a PDSCH/PUSCH based on cross-slot scheduling.

In Rel-16 NR standards, a technology for configuring a minimum offset restriction between DCI and an actual PDSCH/PUSCH scheduled by the DCI has been introduced for the purpose of power saving. When the UE receives DCI in slot n, the UE may receive a PDSCH (or PUSCH) in slot n+K0 (or n+K2). Since the K0 (or K2) value is capable of being set to a minimum of 0, the UE needs to decode the DCI as quickly as possible and buffer signals received in the corresponding slot. In this case, if the minimum value of K0 (or K2) is configured through the minimum scheduling offset restriction (e.g., K0min or K2min), the UE may expect that the PDSCH (or PUSCH) will not be scheduled in a slot preceding slot n+K0min (or n+K2min).

In other words, it is guaranteed that the UE does not need to complete decoding of DCI received in slot until a certain slot. Accordingly, the UE may quickly decode the DCI received in slot n and then sleep until slot n+K0min (or K2min). Alternatively, the UE may decode the DCI received in slot n with low power (e.g., low voltage and/or low clock speed) until slot n+K0min (or n+K2min). According to these operations, the UE may expect power saving benefits.

SSSG switching has been introduced in the Rel-16 NR standards for the purpose of shared spectrum channel access (e.g., NR-U). On the other hand, in the Rel-17 NR standards, SSSG switching has been introduced as PDCCH monitoring adaptation of the UE in the RRC_CONNECTED state and configured with DRX operation to achieve power saving benefits. Another technique introduced for the PDCCH monitoring adaptation is PDCCH monitoring skipping, which involves discontinuing PDCCH monitoring for a certain period of time.

The UE may be configured with a maximum of 10 SS sets per BWP. The UE may monitor PDCCH candidates included in the SS sets (hereinafter referred to as SS set monitoring).

Considering that the UE needs to perform blind decoding (BD) on a PDCCH as the UE does not know at which point in time and in which DCI format the PDCCH will be received, PDCCH monitoring during DRX operation accounts for a significant portion of power consumption.

Such SS sets may be configured to be included or not included in a specific SSSG, and the UE may be instructed to monitor only SS sets included in an SSSG of a specific index through an SSSG switching indication. Therefore, the UE may monitor only some SS sets rather than all 10 SS sets per BWP thereby achieving power saving benefits. In the Rel-16 NR standards, up to two SSSGs may be configured, but three or more SSSGs may be introduced in the future through discussions on power saving in Rel-17.

The present disclosure proposes operations when the UE is simultaneously configured with SSSG switching and cross-slot scheduling simultaneously. In the present disclosure, it is considered that the UE is capable of being configured with K0min/K2min or the minimum value of K0/K2 configurable by RRC is not zero. In other words, both SSSG switching and cross-slot scheduling are technologies for power saving, and UE operations capable of enhancing power saving effects when the UE is simultaneously configured with both the operations.

However, when the UE is simultaneously configured with both cross-slot scheduling and PDCCH monitoring adaptation, the completion of DCI decoding may be delayed due to the scheduling offset restriction. In addition, the delay may cause the time at which the DCI decoding is completed to be later than an application delay, which is the time interval from when the PDCCH monitoring adaptation is instructed to when the PDCCH monitoring adaptation is actually applied.

For example, when the UE is configured with K0min/K2min and the UE is unaware of whether there are PDCCH monitoring adaptation indications in received DCI, the UE may expect that no PDSCH/PUSCH will be scheduled until the time corresponding to K0min/K2min. Thus, the UE may slow down the decoding speed to complete DCI decoding in synchronization with the time corresponding to K0min/K2min. However, when the DCI contains a PDCCH monitoring adaptation indication, even if the UE needs to apply PDCCH monitoring adaptation first because the time after the application delay from the reception of the DCI precedes the time corresponding to K0min/K2min, the UE may fail to apply the PDCCH monitoring adaptation or apply the PDCCH monitoring adaptation belatedly because the UE fails to check the PDCCH monitoring adaptation indication in the DCI.

To address the issue, the present disclosure proposes UE operation methods when the UE is simultaneously configured with both of the aforementioned operations (cross-slot scheduling and SSSG switching). While the present disclosure illustrates an example of using two SSSGs for convenience, the operations proposed in the present disclosure are not limited to having only two SSSGs. For example, three or more SSSGs may be configured.

In the following, the methods proposed in the present disclosure are explained based on SSSG switching of the UE, but the methods proposed in the present disclosure are not limited thereto. It may be understood by those skilled in the art that the methods proposed in the present disclosure may be extended and applied to other power-saving methods based on DCI (e.g., PDCCH monitoring skipping). Thus, it is evident that unless specified otherwise, the methods proposed in the present disclosure are applicable to various types of transmission and reception methods expected by both the BS and UE as long as the principles of the proposed methods are not violated.

While the present disclosure describes the principles of the proposed methods based on the NR system, the proposed methods are not limited to NR transmission and reception formats unless otherwise specified. Therefore, the methods proposed in the present disclosure may be applied to the structure and services of all wireless communication transmission and reception unless the principles of the proposed methods are violated.

In the following description, the classification of methods or options is intended to clarify the description, and the classification is not limitedly interpreted to mean that each should be practiced independently. For example, although each of the methods/options described below may be independently implemented, but at least some of the methods/options may be combined to the extent that they do not conflict with each other.

According to the present disclosure, the BS may configure cross-slot scheduling and SSSG switching to the UE, thereby enhancing the power-saving efficiency of the UE and reducing the latency of transmission and reception of control/traffic information.

To this end, the proposed methods may include the following method: the UE receives information on cross-slot scheduling and SSSG switching from the BS, and then perform PDCCH monitoring, PDSCH transmission, and PUSCH reception based on the information. In addition, the proposed methods may include the following method: the BS determines and configures information on cross-slot scheduling and SSSG switching, informs the UE of the information, and then determine the transmission locations of a PDCCH, PDSCH, and PUSCH based on the corresponding information. Additionally, the proposed methods may include the following process: the UE transmits a signal and channel for informing the capability of the UE and/or UE assistance information, and the BS receives the signal and channel.

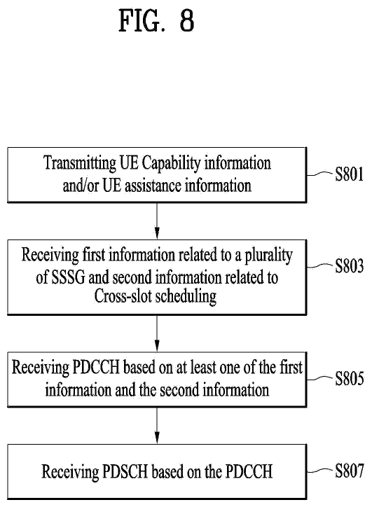

Hereinafter, overall operation processes in which the UE and BS transmit and receive a PDSCH according to the methods proposed in the present disclosure will be described with reference to FIGS. 8 to 10.

FIG. 8 is a diagram for explaining an overall operation process for the UE to receive a PDSCH according to the methods proposed in the present disclosure.

Referring to FIG. 8, the UE may transmit UE capability information and/or UE assistance information to the BS to support the operations proposed in the present disclosure (S801). For example, the capability information and/or UE assistance information may include MinSchedulingOffsetPreference, which is a minimum applicable scheduling offset preferred by the UE, and searchSpaceGroupIdList, which indicates an SSSG including SS sets. S801 may be omitted in specific cases (for example, when the BS already has the information or when each operation method is modified due to the needs of the BS).

The UE may receive first information on cross-slot scheduling and second information on a plurality of SSSGs for SSSG switching transmitted by the BS to support the operations proposed in the present disclosure (S803). In this case, the first information and the second information may be included in common configuration information or different configuration information. For example, the first and second information may be received in a higher layer signal (e.g., system information block (SIB) or RRC signaling).

Alternatively, the first and second information may also be received based on a method of indicating one of a plurality of configurations related to cross-slot scheduling and SSSG switching that are (semi-)statically provided to the UE (for example, through DCI or a MAC CE/header).

For example, the UE may receive a PDCCH containing DCI indicating a change in one SSSG and a change in K0min/K2min (and/or K0/K2) based on the first and second information configured through the higher layer signal (S805).

Based on the information on cross-slot scheduling and the information on SSSG switching included in the PDCCH, the UE may predict a point in time when the UE is capable of receiving a PDSCH and receive the PDSCH at the time when the reception is allowed (S807).

For example, the above-described UE operations according to S803 to S807 may be based on at least one of Method 1 to Method 4.

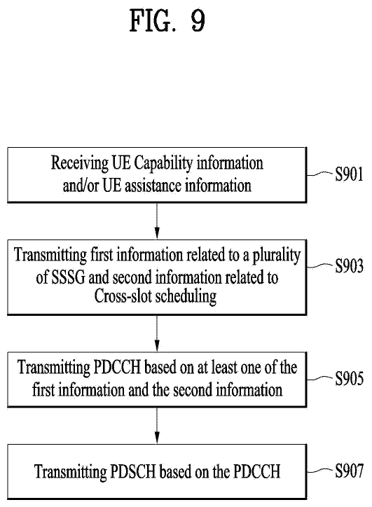

FIG. 9 is a diagram for explaining an overall operation process for the BS to transmit a PDSCH according to the methods proposed in the present disclosure.

Referring to FIG. 9, the BS may receive UE capability information and/or UE assistance information from the UE to support the operations proposed in the present disclosure (S901). For example, the capability information and/or UE assistance information may include MinSchedulingOffsetPreference, which is a minimum applicable scheduling offset preferred by the UE, and searchSpaceGroupIdList, which indicates an SSSG including SS sets. S901 may be omitted in specific cases (for example, when the BS already has the information or when each operation method is modified due to the needs of the BS).

The BS may transmit first information on cross-slot scheduling and second information on a plurality of SSSGs for SSSG switching to support the operations proposed in the present disclosure (S903). In this case, the first information and the second information may be included in common configuration information or different configuration information. For example, the first and second information may be transmitted in a higher layer signal (e.g., SIB or RRC signaling).

Alternatively, the first and second information may also be transmitted based on a method of indicating one of a plurality of configurations related to cross-slot scheduling and SSSG switching that are (semi-)statically provided to the UE (for example, through DCI or a MAC CE/header).

For example, the BS may transmit a PDCCH containing DCI indicating a change in one SSSG and a change in K0min/K2min (and/or K0/K2) based on the first and second information configured through the higher layer signal (S905).

Based on the information on cross-slot scheduling and the information on SSSG switching included in the PDCCH, the BS may determine a point in time when the BS is capable of transmitting a PDSCH and transmit the PDSCH at the time when the transmission is allowed (S907).

For example, the above-described BS operations according to S803 to S807 may be based on at least one of Method 1 to Method 4.

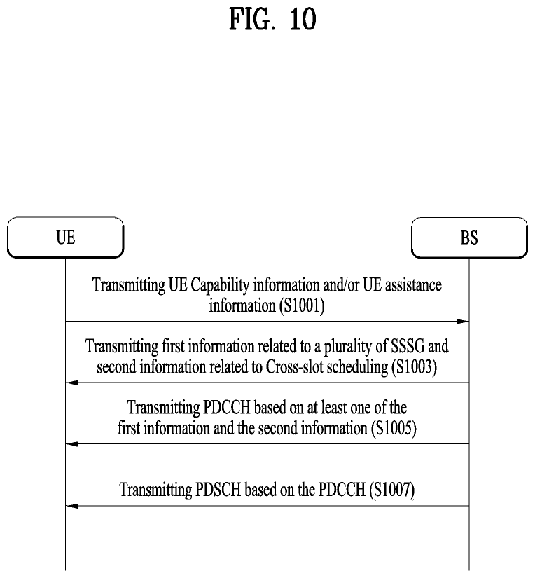

FIG. 10 is a diagram for explaining an overall operation process for PDSCH transmission and reception in a network according to the methods proposed in the present disclosure.

Referring to FIG. 10, the BS may receive UE capability information and/or UE assistance information from the UE to support the operations proposed in the present disclosure (S1001). For example, the capability information and/or UE assistance information may include MinSchedulingOffsetPreference, which is a minimum applicable scheduling offset preferred by the UE, and searchSpaceGroupIdList, which indicates an SSSG including SS sets. S1001 may be omitted in specific cases (for example, when the BS already has the information or when each operation method is modified due to the needs of the BS).

The BS may transmit to the UE first information on cross-slot scheduling and second information on a plurality of SSSGs for SSSG switching to support the operations proposed in the present disclosure (S1003). In this case, the first information and the second information may be included in common configuration information or different configuration information. For example, the first and second information may be transmitted in a higher layer signal (e.g., SIB or RRC signaling).

Alternatively, the first and second information may also be transmitted based on a method of indicating one of a plurality of configurations related to cross-slot scheduling and SSSG switching that are (semi-)statically provided to the UE (for example, through DCI or a MAC CE/header).

For example, the BS may transmit to the UE a PDCCH containing DCI indicating a change in one SSSG and a change in K0min/K2min (and/or K0/K2) based on the first and second information configured through the higher layer signal (S1005).

Based on the information on cross-slot scheduling and the information on SSSG switching included in the PDCCH, the BS may determine a point in time when the BS is capable of transmitting a PDSCH and transmit the PDSCH to the UE at the time when the transmission is allowed (S1007).

For example, the above-described BS operations according to S1003 to S1007 may be based on at least one of Method 1 to Method 4.

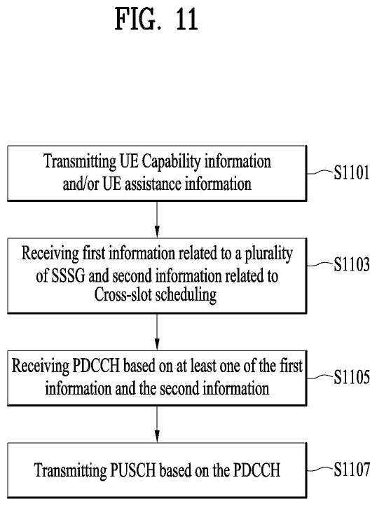

The overall operation processes for the UE and BS to transmit and receive a PUSCH according to the methods proposed in the present disclosure will be described with reference to FIGS. 11 to 13.

FIG. 11 is a diagram for explaining an overall operation process for the UE to transmit a PUSCH according to the methods proposed in the present disclosure.

Referring to FIG. 11, the UE may transmit UE capability information and/or UE assistance information to the BS to support the operations proposed in the present disclosure (S1101). For example, the capability information and/or UE assistance information may include MinSchedulingOffsetPreference, which is a minimum applicable scheduling offset preferred by the UE, and searchSpaceGroupIdList, which indicates an SSSG including SS sets. S1101 may be omitted in specific cases (for example, when the BS already has the information or when each operation method is modified due to the needs of the BS).

The UE may receive first information on cross-slot scheduling and second information on a plurality of SSSGs for SSSG switching transmitted by the BS to support the operations proposed in the present disclosure (S1103). In this case, the first information and the second information may be included in common configuration information or different configuration information. For example, the first and second information may be received in a higher layer signal (e.g., system information block (SIB) or RRC signaling).

Alternatively, the first and second information may also be received based on to a method of indicating one of a plurality of configurations related to cross-slot scheduling and SSSG switching that are (semi-)statically provided to the UE (for example, through DCI or a MAC CE/header).

For example, the UE may receive a PDCCH containing DCI indicating a change in one SSSG and a change in K0min/K2min (and/or K0/K2) based on the first and second information configured through the higher layer signal (S1105).

Based on the information on cross-slot scheduling and the information on SSSG switching included in the PDCCH, the UE may predict a point in time when the UE is capable of transmitting a PUSCH and transmit the PUSCH at the time when the transmission is allowed (S1107).

For example, the above-described UE operations according to S1103 to S1107 may be based on at least one of Method 1 to Method 4.

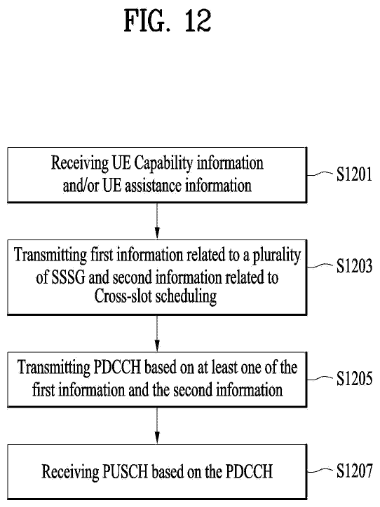

FIG. 12 is a diagram for explaining an overall operation process for the BS to receive a PUSCH according to the methods proposed in the present disclosure.

Referring to FIG. 12, the BS may receive UE capability information and/or UE assistance information from the UE to support the operations proposed in the present disclosure (S1201). For example, the capability information and/or UE assistance information may include MinSchedulingOffsetPreference, which is a minimum applicable scheduling offset preferred by the UE, and searchSpaceGroupIdList, which indicates an SSSG including SS sets. S901 may be omitted in specific cases (for example, when the BS already has the information or when each operation method is modified due to the needs of the BS).

The BS may transmit first information on cross-slot scheduling and second information on a plurality of SSSGs for SSSG switching to support the operations proposed in the present disclosure (S1203). In this case, the first information and the second information may be included in common configuration information or different configuration information. For example, the first and second information may be transmitted in a higher layer signal (e.g., SIB or RRC signaling).

Alternatively, the first and second information may also be transmitted based on a method of indicating one of a plurality of configurations related to cross-slot scheduling and SSSG switching that are (semi-)statically provided to the UE (for example, through DCI or a MAC CE/header).

For example, the BS may transmit a PDCCH containing DCI indicating a change in one SSSG and a change in K0min/K2min (and/or K0/K2) based on the first and second information configured through the higher layer signal (S1205).

Based on the information on cross-slot scheduling and the information on SSSG switching included in the PDCCH, the BS may determine a point in time when the BS is capable of receiving a PUSCH and receive the PUSCH at the time when the reception is allowed or transmit a PDSCH (S1207).

For example, the above-described BS operations according to S1203 to S1207 may be based on at least one of Method 1 to Method 4.

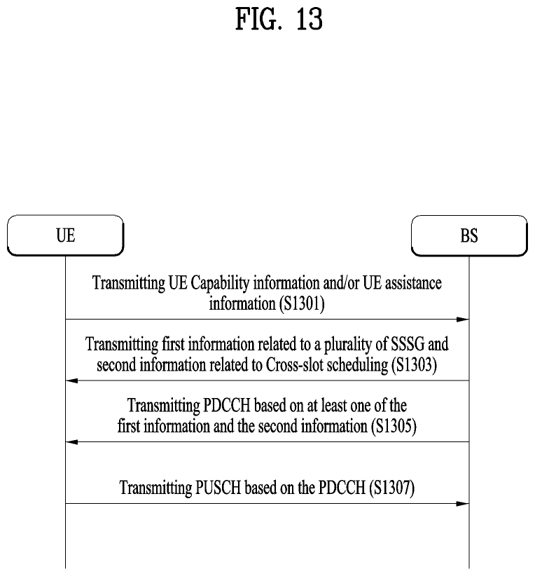

FIG. 13 is a diagram for explaining an overall operation process for PUSCH transmission and reception in a network according to the methods proposed in the present disclosure.

Referring to FIG. 13, the BS may receive UE capability information and/or UE assistance information from the UE to support the operations proposed in the present disclosure (S1301). For example, the capability information and/or UE assistance information may include MinSchedulingOffsetPreference, which is a minimum applicable scheduling offset preferred by the UE, and searchSpaceGroupIdList, which indicates an SSSG including SS sets. S1301 may be omitted in specific cases (for example, when the BS already has the information or when each operation method is modified due to the needs of the BS).

The BS may transmit to the UE first information on cross-slot scheduling and second information on a plurality of SSSGs for SSSG switching to support the operations proposed in the present disclosure (S1303). In this case, the first information and the second information may be included in common configuration information or different configuration information. For example, the first and second information may be transmitted in a higher layer signal (e.g., SIB or RRC signaling).

Alternatively, the first and second information may also be transmitted based on a method of indicating one of a plurality of configurations related to cross-slot scheduling and SSSG switching that are (semi-)statically provided to the UE (for example, through DCI or a MAC CE/header).

For example, the BS may transmit to the UE a PDCCH containing DCI indicating a change in one SSSG and a change in K0min/K2min (and/or K0/K2) based on the first and second information configured through the higher layer signal (S1305).

Based on the information on cross-slot scheduling and the information on SSSG switching included in the PDCCH, the BS may determine a point in time when the BS is capable of receiving a PUSCH and receive the PUSCH from the UE at the time when the reception is allowed or transmit a PDSCH to the UE (S1307).

For example, the above-described BS operations according to S1303 to S1307 may be based on at least one of Method 1 to Method 4.

In other words, the methods proposed in the present disclosure may be applied by selecting some of the following methods. Each method may operate independently without any combinations, or one or more methods may operate in combination. Some of the terms, symbols, and orders used herein to describe the present disclosure may be replaced with other terms, symbols, and orders as long as the principles of the present disclosure are maintained.

Hereinafter, the principles of the methods proposed in the present disclosure will be described by providing illustrative examples of SSSG switching for power saving purposes, which has been discussed in the Rel-17 NR standards, and SSSG switching operation based on the Rel-16 standards. However, the proposed methods are not limited to the types of UE SSSG switching operations unless otherwise stated.

In addition, since the SSSG switching for power saving purposes is commonly designed as PDCCH monitoring adaptation along with PDCCH monitoring skipping, the methods described as examples of SSSG switching in the present disclosure are equally applicable to operations similar to PDCCH monitoring skipping.

Therefore, it is evident that unless specified otherwise, the methods proposed in the present disclosure are applicable to PDCCH monitoring adaptation and cross-slot scheduling based on transmission and reception of other types of UCI as long as the principles of the proposed methods are not violated.

For example, when SSSG #0 is data-efficient for the UE, the number of times of PDCCH monitoring therein may increase. When SSSG #1 aims to power save, the number of times of PDCCH monitoring therein may decrease. In this case, cross-slot scheduling configurable via RRC for each BWP may not always need to be the same, regardless of the current monitoring SSSG of the UE.

For example, if the UE is monitoring SSSG #0, a large amount of data transmission may be expected, and thus a high minimum scheduling offset restriction value may be configured. If a high minimum value of K0/K2 is configured through RRC, it may be disadvantageous for the UE in terms of latency. On the contrary, when a low minimum scheduling offset restriction value and/or a low minimum value of K0/K2 is configured, the expected data transmission based on SSSG monitoring may be terminated quickly, which may be beneficial in terms of power consumption efficiency.

The present disclosure assumes that the UE is configured with both cross-slot scheduling and SSSG switching. Typically, the BS may configure SSSGs each including SS sets to the UE through searchSpaceGroupIdList in an RRC IE SearchSpace. In the Rel-16 NR standards, SSSG switching is indicated through DCI format 2_0. However, in Rel-17, DCI format x_1, DCI format x_2, (where x is an arbitrary integer), DCI format 2_6, and so on are considered as additional DCI formats for indicating SSSG switching. The UE may receive an indication for SSSG switching in DCI and change the currently monitored SSSG. In general, SSSGs may be configured without restrictions, but the SSSGs may categorized into: SSSGs where PDCCH monitoring is frequently performed for data traffic transmission; and SSGs where PDCCH monitoring is performed at low frequency for power saving purposes.

Table 3 below shows the UE operations related to the minimum applicable scheduling offset for cross-slot scheduling defined in 3GPP TS 38.213.

TABLE 3
When the UE is configured with minimumSchedulingOffsetK0 in an active DL BWP it
applies a minimum scheduling offset restriction indicated by the ‘Minimum applicable
scheduling offset indicator’ field in DCI format 1_1 or DCI format 0_1 if the same
field is available. When the UE is configured with minimumSchedulingOffsetK0 in an
active DL BWP and it has not received ‘Minimum applicable scheduling offset
indicator’ field in DCI format 0_1 or 1_1, the UE shall apply a minimum scheduling
offset restriction indicated based on ‘Minimum applicable scheduling offset indicator’
value ‘0’. When the minimum scheduling offset restriction is applied the UE is not
expected to be scheduled with a DCI in slot n to receive a PDSCH scheduled with
$C ‐ RNTI , CS ‐ RNTI or MCS ‐ C ‐ RNTI with {K}_{0} smaller than ⌈ {K}_{0 min} \cdot \frac{{2}^{{μ}^{′}}}{{2}^{μ}} ⌉ ,$
where K₀ₘᵢₙ and μ are the applied minimum scheduling offset restriction and the
numerology of the active DL BWP of the scheduled cell when receiving the DCI in
slot n, respectively, and μ′ is the numerology of the new active DL BWP in case
of active DL BWP change in the scheduled cell and is equal to μ, otherwise.

As described above, for cross-slot scheduling, one or two values of minimumSchedulingOffsetK0 (or minimumSchedulingOffsetK2) may be configured for each BWP through RRC Based on information on the UE and the preferred K0min (or K2min) value of the UE. Additionally, the BS may configure any one of the one or two values of K0min (or K2min) to the UE through zero or one bit of a minimum applicable scheduling offset indicator in DCI format 0_1 or DCI format 1_1. For example, if two values of K0min (or K2min) are configured through the RRC layer, DCI format 0_1 or DCI format 11 may indicate one of the two values with one bit. If one value of K0min (or K2min) is configured through the RRC layer, one bit of DCI format 0_1 or DCI format 1_1 may indicate whether to apply the configured one value of K0min (or K2min) or not to apply the minimum applicable scheduling offset (That is, the value of K0min or K2min is 0).

Alternatively, the UE may not be configured with minimumSchedulingOffsetK0 (or minimumSchedulingOffsetK2). Table 4 shows the values of K0/K2 configured through RRC defined in 3GPP TS 38.331. Table 4 shows an example configuration for K0, and the configuration for K2 is omitted since the configuration for K2 is similar to that for K0.

TABLE 4

PDSCH-TimeDomainResourceAllocationList ::= SEQUENCE
(SIZE(1..maxNrofDL-Allocations)) OF
PDSCH-TimeDomainResourceAllocation
PDSCH-TimeDomainResourceAllocation ::= SEQUENCE {
k0 INTEGER(0..32) OPTIONAL, -- Need S
mappingType ENUMERATED {typeA, typeB},
startSymbolAndLength INTEGER (0..127)
}

As shown in Table 4, multiple K0/K2 values may be configured. When the minimum configurable value among the multiple K0/K2 values is not 0, a scheduled PDSCH/PUSCH may not assigned to the same slot as received DCI, and thus the UE may consider that cross-slot scheduling is indicated

The present disclosure proposes UE operations when the UE is simultaneously configured with SSSG switching and cross-slot scheduling. Additionally, it is proposed that the UE is configured with different cross-slot scheduling for each SSSG.

In addition, SSSGs may be configured to be suitable for the expected UE operation. Accordingly, if different cross-slot scheduling is configured, this may lead to improvement of transmission latency and power saving effects. To this end, the present disclosure proposes methods that allow the UE instructed to perform these two operations simultaneously to perform the operations with no issues.

### [Method 1] Method of Configuring Different Minimum Applicable Scheduling Offset (e.g., K0min or K2min) Based on SSSG Including SS Sets Monitored by UE

As mentioned earlier, the proposals of the present disclosure assume that the UE is configured with both cross-slot scheduling and SSSG switching. The UE is configured with a minimum applicable scheduling offset through a higher layer parameter minimumSchedulingOffsetK0 or minimumSchedulingOffsetK2. In addition, two or three or more SSSGs are configured through a higher layer parameter searchSpaceGroupIdList. In this case, the UE operation based on the minimum applicable scheduling offset may be the same, regardless of SSSGs.

In general, among two SSSGs configured to the UE, SSSG #0 may be referred to as a data-efficient SSSG, and SSSG #1 may be referred to as an SSSG for power saving. In other words, SSSG #0 is an SSSG that includes a relatively large number of SS sets or SS sets with relatively short periods to increase the PDCCH monitoring frequency when a large volume of data transmission is expected. SSSG #1 is an SSSG that includes a relatively small number of SS sets or SS sets with relatively long periods to reduce the PDCCH monitoring frequency for power saving.

For example, when K0min is set to 6 slots, the UE may receive DCI indicating switching to SSSG #0 while monitoring SSSG #1. When a high volume of data traffic is expected, the BS may indicate switching from SSSG #1 to SSSG #0 to instruct the UE to monitor a PDCCH more frequently. In this case, K0min=6 slots, which is configured for the purpose of power saving, may not be appropriate for smooth data transmission, and as a result, latency issues may occur.

According to the existing NR standards, a new value of K0min may be configured by DCI format 1_1. However, a minimum application delay of at least 6 slots is required before the new K0min value is applied. For SSSG switching for power saving in licensed bands, various DCI formats such as DCI format 0_2, DCI format 1_2, or DCI format 2_6 are being considered, in addition to DCI format 0_1 and DCI format 1_1, which include a minimum applicable scheduling offset indicator field. Thus, it may be challenging to simultaneously provide an SSSG switching indication and configure new values of K0min or K2min.

In other words, configuring and applying the same minimum applicable scheduling offset to an SSSG for data transmission (e.g., SSSG #0) and an SSG for power saving (e.g., SSSG #1) may lead to latency issues to the UE. To address these issues, a method of configuring to the UE a different minimum applicable scheduling offset for each SSSG is proposed in Method 1 of the present disclosure.

In the Rel-16 NR standards, the UE is configured with the minimum applicable scheduling offset for each BWP through minimumSchedulingOffsetK0 in PDSCH-config IE and minimumSchedulingOffsetK2 in PUSCH-config IE.

Up to two values may be configured for each of these variables. One of the two values may be indicated through the minimum applicable scheduling offset indicator field of DCI format 0_1 and 1_1. Table 5 below is an excerpt from 3GPP TS 38.212.

TABLE 5
Minimum applicable scheduling offset indicator—0 or 1 bit
0 bit if higher layer parameter minimumSchedulingOffsetK2 is not configured;
1 bit if higher layer parameter minimumSchedulingOffsetK2 is configured. The 1 bit
indication is used to determine the minimum applicable K2 for the active UL BWP
and the minimum applicable K0 value for the active DL BWP, if configured
respectively, according to Table 7.3.1.1.2-33. If the minimum applicable K0 is
indicated, the minimum applicable value of the aperiodic CSI-RS triggering offset
for an active DL BWP shall be the same as the minimum applicable K0 value.
Table 7.3.1.1.2-33: Joint indication of minimum applicable scheduling offset K0/K2

| | Minimum applicable K0 for | Minimum applicable K2 for |
|---|---|---|
| Bit field | the active DL BWP, if | the active UL BWP, if |
| mapped | minimumSchedulingOffsetK0 | minimumSchedulingOffsetK2 |
| to index | is configured for the DL BWP | is configured for the UL BWP |
| 0 | The first value configured by | The first value configured by |
| | minimumSchedulingOffsetK0 | minimumSchedulingOffsetK2 for |
| | for the active DL BWP | the active UL BWP |
| 1 | The second value configured | The second value configured |
| | by minimumSchedulingOffsetK0 | by minimumSchedulingOffsetK2 |
| | for the active DL BWP if the | for the active UL BWP if the |
| | second value is configured; | second value is configured: |
| | 0 otherwise | 0 otherwise |

### [Method 1-1] Method of Indicating/Configuring First/Second Values of Minimum Applicable Scheduling Offset (e.g., K0min or K2min) of UE Differently for Each SSSG

Method 1-1 proposes an operation of indicating/configuring a different minimum applicable scheduling offset for each SSSG through the minimum applicable scheduling offset indicator field of DCI format 0_1 and DCI format 1_1 while the RRC configuration of the UE remains the same as before.

In the existing Rel-16 NR standards, up to two minimum applicable scheduling offsets may be configured by the RRC layer. In addition, which one of the two values configured by the RRC layer is applied may be indicated by DCI. Therefore, assuming that two SSSGs are configured for general SSSG switching, one value may be configured for each SSSG. In other words, if two K0min (or K2min) values are configured, each of the K0min (or K2min) values may be mapped to each SSSG.

For example, the value when the bit field mapped to index in Table 7.3.1.1.2-33 of Table 5 is 0 may be set as the default minimum applicable scheduling offset of SSSG #0, and the value when the bit field mapped to index is 1 may be set as the default minimum applicable scheduling offset of SSSG #1. Thereafter, when SSSG switching is indicated by DCI format 0_1 and DCI format 1_1, the minimum applicable scheduling offset for the corresponding SSSG may be changed.

In other words, if the UE is instructed to monitor SSSG #0, unless otherwise specifically instructed, the UE may monitor SSSG #0 by setting the value when the bit field mapped to index is 0 as K0min (or K2min) and then detect and decode a PDCCH. On the other hand, if the UE is instructed to monitor SSSG #1, unless otherwise specifically instructed, the UE may monitor SSSG #1 by setting the value when the bit field mapped to index is 1 as K0min (or K2min) and then detect and decode the PDCCH.

When the UE is configured with K0min (or K2min) as in Method 1-1, no additional fields may be required in RRC configurations or DCI as in the existing Rel-16 NR standards. In addition, even when SSSG switching is indicated by DCI other than DCI format 0_1 and DCI format 1_1, the minimum applicable scheduling offset to be applied depending on the SSSG that the UE is currently monitoring may vary.

For example, the default minimum applicable scheduling offset of SSSG #0 may be initially set to one slot, and the default minimum applicable scheduling offset of SSSG #1 may be initially set to four slots. When the UE monitors the PDCCH in SSSG #1 for power saving, if the BS has no data scheduling at the moment but instructs SSSG switching to SSSG #0 through DCI rather than DCI format 0_1 and DCI format 1_1 for expected data traffic in the future, the UE may expect scheduling of a PDSCH (or PUSCH) with a minimum applicable scheduling offset of 1 slot while monitoring SSSG #0.

The minimum applicable scheduling offset configured to the UE remains at the current value until the minimum applicable scheduling offset is updated with a new value. As a result, there may be some latency in configuring values other than the first/second value already configured by the RRC layer. Therefore, if the UE is configured with the default minimum applicable scheduling offset for each SSSG as in Method 1-1, the UE may interpret the minimum applicable scheduling offset field of DCI format 0_1 and DCI format 1_1 differently.

For example, if the bit value of the minimum applicable scheduling offset field in DCI format 0_1 and DCI format 1_1 is 0, the UE may set the value of K0min (or K2min) to 0 without applying the default minimum applicable scheduling offset. In other words, when the bit value of the minimum applicable scheduling offset field is 0, the UE may not to apply cross-slot scheduling.

As another example, when relatively high minimum applicable scheduling offset values are configured for two SSSGs, if a large amount of data transmission is expected, the BS may provide a dynamic indication in DCI without changing the current minimum applicable scheduling offset values configured through the RRC layer.

As another example, the method may be used to change the minimum applicable scheduling offset as in the prior art. For example, regardless of SSSGs monitored due to SSSG switching, when the bit value of the minimum applicable scheduling offset field of DCI is 0 (or 1), the value configured for SSSG #0 (or SSSG #1) may be updated to a new value. When the UE is instructed to switch to SSSG #1, if the corresponding bit value is 0, the UE may use the value corresponding to the default minimum applicable scheduling offset of SSSG #0 as the minimum applicable scheduling offset for SSSG #1. Alternatively, the method may be used in the form of toggling, where a bit value of 0 indicates maintaining the current value, while a bit value of 1 indicates changing the current value to a different value.

The minimum applicable scheduling offset indicator field is present only in DCI format 1_1 and DCI format 0_1, but for the methods proposed in the present disclosure, this field may be defined in DCI formats such as DCI format 0_2, DCI format 1_2, or DCI format 2_6, which are candidate DCI formats for indicating SSSG switching. In this case, if SSSG switching is simultaneously indicated with a change in the minimum applicable scheduling offset, the UE may operate as described above.

According to Method 1-1, since K0min (or K2min) is configured for each SSSG, K0min (or K2min) satisfying the configuration purpose for each SSSG may be applied simply by indicating SSSG switching even if K0min (or K2min) is not separately indicated by DCI. This operation enables more efficient implementation of the SSSG switching, thereby enhancing power saving effects. In addition, fields in the DCI intended for indicating K0min (or K2min) may be used for different purposes, or the size of the DCI may be reduced.

### [Method 1-2] Method of Configuring and Indicating Minimum Applicable Scheduling Offset (e.g., K0min or K2min) of UE Differently for Each SSSG Through RRC Layer.

According to Method 1-1, cross-slot scheduling is capable of being instructed/configured simultaneously with SSSG switching without changes to the Rel-16 NR standard. However, there may be a lack of configurability for the minimum applicable scheduling offset for each SSSG, and it may be challenging to provide indications through DCIs other than DCI format 0_1 and DCI format 1_1.

Therefore, Method 1-2 proposes an operation of configuring and indicating the minimum applicable scheduling offset of the UE independently for each SSSG per BWP. As described above, in the Rel-16 NR standards, the minimum applicable scheduling offset is configured for each BWP. However, according to Method 1-2, K0min (or K2min) may be configured for each SSSG (i.e., RRC configuration per SSSG per BWP).

For example, if there are two SSSGs, minimumSchedulingOffsetK0 may be divided into minimumSchedulingOffsetK0-Group0 and minimumSchedulingOffsetK0-Group1 such that each SSSG has its own configuration. Alternatively, a parameter that allows similar configurations such as minimumSchedulingOffsetK0-Alternative may be added. Similarly, minimumSchedulingOffsetK2 may be divided into minimumSchedulingOffsetK2-Group0 and minimumSchedulingOffsetK2-Group1, or an additional parameter such as minimumSchedulingOffsetK2-Alternative may be configured.

If additional parameters are configured in addition to minimumSchedulingOffsetK0 (or minimumSchedulingOffsetK2), the UE can know that the minimum applicable scheduling offset is configured differently for each SSSG. On the other hand, except for minimumSchedulingOffsetK0 (or minimumSchedulingOffsetK2), if additional parameters are not configured or set to inappropriate values, the UE may know that the same minimum applicable scheduling offset is configured for all SSSGs.

Whether the minimum applicable scheduling offset is configured for each SSSG may be determined by the BS based on UE assistance information or UE capability information from the UE. Before configuring the minimum applicable scheduling offset to the UE, the BS may refer to the preference configuration of the UE (e.g., UE assistance information or UE capability information).

Table 6 below shows transmission of UE assistance information defined in 3GPP TS 38.331.

TABLE 6
MinSchedulingOffsetPreference-r16 ::= SEQUENCE {
preferredK0-r16 SEQUENCE {
preferredK0-SCS-15kHz-r16 ENUMERATED {sl1, sl2, sl4, sl6}
OPTIONAL,
preferredK0-SCS-30kHz-r16 ENUMERATED {sl1, sl2, sl4, sl6}
OPTIONAL,
preferredK0-SCS-60kHz-r16 ENUMERATED {sl2, sl4, sl8, sl12}
OPTIONAL,
preferredK0-SCS-120kHz-r16 ENUMERATED {sl2, sl4, sl8, sl12}
OPTIONAL
} OPTIONAL.
preferredK2-r16 SEQUENCE {
preferredK2-SCS-15kHz-r16 ENUMERATED {sl1, sl2, sl4, sl6}
OPTIONAL,
preferredK2-SCS-30kHz-r16 ENUMERATED {sl1, sl2, sl4, sl6}
OPTIONAL,
preferredK2-SCS-60kHz-r16 ENUMERATED {sl2, sl4, sl8, sl12}
OPTIONAL,
preferredK2-SCS-120kHz-r16 ENUMERATED {sl2, sl4, sl8, sl12}
OPTIONAL
} OPTIONAL
}
minSchedulingOffsetPreference indicates the UE's preferences on
minimumSchedulingOffset of cross-slot scheduling for power saving.

The UE may differentiates differentiate preferences for each SSSG and provide the preferences to the BS in the corresponding UE assistance information.

For example, a parameter preferenceDifferenceBetweenGroups may be added to distinguish between TRUE and FALSE. In the case of TRUE, the UE may inform the BS of preferredK0-SCS-15 kHz (or similar parameters) for each SSSG as many as the number of SSSGs. If the UE is configured with SSSG #0 and SSSG #1, the UE can inform the BS of preferredK0-SCS-15 kHz as {sl1, sl6}. These values may be interpreted in the order of SSSG indices (from the lowest to the highest). Therefore, in the above example, preferredK0-SCS-15 kHz for SSSG #0 may be one slot, and preferredK0-SCS-15 kHz for SSSG #1 may be 6 slots. If preferenceDifferenceBetween Groups is FALSE or ABSENT, the UE may inform the BS of only one value of preferredK0-SCS-15 kHz as in the prior art.

When the minimum applicable scheduling offset is configured differently for each SSSG, if the UE receives an indication to change the minimum applicable scheduling offset, the UE may change the K0min (or K2min) value corresponding to the currently monitored SSSG as in the prior art.

For example, it is assumed that the UE is currently monitoring SSSG #0. It is also assumed that when the minimum applicable scheduling offset is based on a first value of K0min (or K2min), a PDSCH/PUSCH is scheduled with no SSSG switching indication through DCI, and the bit value of the minimum applicable scheduling offset indicator bit value is indicated as 1. In this case, the minimum applicable scheduling offset may be changed to a second value of K0min (or K2min) after the application delay as in the existing NR UE operation. However, the above-described change is limited to SSSG #0 only. In other words, since a change in the minimum applicable scheduling offset is instructed when the UE is monitoring SSSG #0, the UE may change only the value of K0min (or K2min) corresponding to SSSG #0 without changing the value of K0min (or K2min) corresponding to SSSG #1.

In this case, if a change in the minimum applicable scheduling offset is indicated along with an SSSG switching indication, the UE may change the K0min (or K2min) value corresponding to SSSG #1 without changing the K0min (or K2min) value corresponding to SSSG #0.

In the Rel-16 NR standards, the SS sets capable of being in an SSSG are limited to Type3-PDCCH CSS sets and USS sets. Thus, K0min (or K2min) values may be separately configured for SS sets that are not included in any SSSG. Subsequently, when monitoring these SS sets, the separately configured K0min (or K2min) values may be applied to decode DCI.

SS sets that are not included in any SSSG may overlap with SS sets that are included in a specific SSSG. In this case, the UE may follow an indication/configuration provided by the BS to determine which K0min (or K2min) to select.

For instance, assuming that K0min for SS sets not included in any SSSG is a, K0min for SSSG #0 is b, and K0min for SSSG #1 is c, if there is an overlap with SS sets monitored by the UE instructed to switch to SSSG #0, the UE may select the K0min value based on min (a, c) or max (a, c), which may be determined by the indication from the BS.

For example, if the BS prioritizes power saving benefits, the BS may select and indicate max (a, c), and if the BS prioritizes smooth data transmission, the BS may select and indicate min (a, c). Alternatively, the BS may instruct to always select a in all cases. The above-described indications may be configured through the RRC layer. After configuring one or multiple values, the BS may indicate one value selected by the BS among the multiple values to the UE through DCI/MAC CE.

According to Method 1-2, multiple values of K0min (or K2min) may be configured for each SSSG and indicated in DCI. That is, the number of K0min (or K2min) values configurable for each SSSG may increase. This has the effect of increasing flexibility in that the BS is capable of configuring an appropriate value of K0min (or K2min) and an appropriate SSSG to the UE depending on the expected amount of data and the degree of power saving currently required.

[Method 2] Operation for Changing Minimum Applicable Scheduling Offset of UE when Change in Minimum Applicable Scheduling Offset is Indicated Along with SSSG Switching

Method 2 proposes UE operations when SSSG switching is indicated together with a change in the minimum applicable scheduling offset. As described in Method 1, a change in the minimum applicable scheduling offset may be indicated simultaneously with SSSG switching. In addition to DCI format 1_1 and DCI format 0_1 for indicating SSSG switching, various DCI formats that do not include the minimum applicable scheduling offset indicator field may also be considered in implementing the proposals of Method 1.

For the methods proposed in the present disclosure, the minimum applicable scheduling offset indicator field may also be defined in DCI format 0_2, DCI format 1_2, and/or DCI format 2_6, which are candidate DCI formats for indicating SSSG switching. In Method 2, the following scenarios are considered: when PDSCH/PUSCH scheduling is indicated together with SSSG switching and a change in the minimum applicable scheduling offset; and when only a change in the minimum applicable scheduling offset is indicated without PDSCH/PUSCH scheduling.

When PDSCH/PUSCH scheduling is indicated together with SSSG switching and a change in the minimum applicable scheduling offset through DCI format 0_1 and DCI format 1_1, the UE needs to consider various factors to execute the corresponding indication.

Hereinafter, Method 2 will be described based on a PDSCH, for convenience of explanation of embodiments, but Method 2 may be equally applied to a PUSCH.

Table 7 below shows the operation method by which the UE applies a changed value when a change in the minimum applicable scheduling offset is indicated, which is defined in 3GPP TS 38.214.

TABLE 7
When the DCI format 0_1 or 1_1 with ‘Minimum applicable scheduling offset
indicator’ field indicating a change to the applied K₀ₘᵢₙ or K₂ₘᵢₙ is contained within the
first three symbols of slot n, the value of application delay X is determined by,
$X = max ( ⌈ {K}_{0 minOld} \cdot \frac{{2}^{{μ}_{PDCCH}}}{{2}^{{μ}_{PDSCH}}} ⌉ , {Z}_{μ} ) where {K}_{0 min Old} is the$
currently applied K₀ₘᵢₙ value of the active DL BWP in the scheduled cell and is zero,
if minimumSchedulingOffsetK0 is not configured for the active DL BWP in the
scheduled cell, Z_{μ} is determined by the subcarrier spacing of the active DL BWP in
the scheduling cell in slot n, and given in Table 5.3.1-1, and μ_{PDCCH} and μ_{PDSCH} are the
sub-carrier spacing configurations for PDCCH of the active DL BWP in the
scheduling cell and PDSCH of the active DL BWP in the scheduled cell, respectively,
in slot n. After indication of a change to the applied K₀ₘᵢₙ or K₂ₘᵢₙ of the scheduled cell
in slot n of the scheduling cell, if there is an active DL BWP change in the scheduling
cell before slot n + X, the new K₀ₘᵢₙ and/or K₂ₘᵢₙ values are applied from the first slot
no earlier than the start of slot n + X based on the sub-carrier spacing configuration
of the active DL BWP in the scheduling cell in slot n.
When the DCI format 0_1 or 1_1 with ‘Minimum applicable scheduling offset
indicator’ field is received outside the first three symbols of the slot, value of Z_{μ} from
Table 5.3.1-1 is incremented by one before determining the application delay X.
Table 5.3.1-1: Definition of Z_{μ}

| μ | Z_{μ} |
|---|---|
| 0 | 1 |
| 1 | 1 |
| 2 | 2 |
| 3 | 2 |

The UL changes K0min (or K2min) in slot n+X, where X is determined according to Table 7. However, SSSG switching is not considered in the UL operations according to Table 7. Therefore, Method 2 proposes UL operations when SSSG switching is indicated together with a change in the minimum applicable scheduling offset.

The current NR UL may change K0min in slot n+X. However, when PDSCH/PUSCH scheduling and SSSG switching are instructed simultaneously with a change in the minimum applicable scheduling offset, the UL needs to operate in a different way from the conventional method.

As proposed in Method 1, if the UE is instructed to change K0min (or K2min) simultaneously with SSSG switching, the UE needs to change K0min (or K2min) for an SSSG after performing the SSSG switching. Even when the UE performs SSSG switching, an application delay (Y) may be required, and the application delay (Y) may be in units of slots or symbols. If the application delay (Y) is in units of symbols, the SSSG switching may be applied at the slot boundary after the last symbol.

In this case, for example, the UE may change K0min (or K2min) in slot n+max (X, Y) rather than slot n+X. Additionally, when SSSG switching is indicated together with a change in K0min (or K2min) through scheduling DCI, the change in K0min (or K2min) may be applied at the first slot boundary after ACK/NACK transmission for a scheduled PDSCH (for example, PUSCH transmission in the case of DCI format 0_1). The above operation is to transmit the scheduled PDSCH without any issues and to perform SSSG switching after a response (PUCCH transmission and PUSCH transmission). After the ACK/NACK transmission (for example, PUSCH transmission in the case of DCI format 0_1), the change in K0min (or K2min) may be performed when it is confirmed that SSSGs to be monitored are aligned after the UE and BS perform SSSG switching.

For example, the UE may transmit the PUCCH/PUSCH in response to the PDSCH. If the UE successfully detects a PDCCH in an SSSG indicated by the BS and confirms that there is no misalignment between SSSGs monitored by the BS and UE, the UE may change K0min (or K2min).

In the case of non-scheduling DCI (e.g., DCI format 0_2, DCI format 1_2, or DCI format 2_6), K0min (or K2min) may be changed in slot n+max (X, Y), and there may be no ACK/NACK transmission for the scheduled PDSCH (e.g., PUSCH transmission in the case of DCI format 0_1) Therefore, Y may be configured in units of slots.

If the BS does not receive from the UE any response to the PDCCH in an SSSG after SSSG switching for a certain period of time (T), the BS may determine that the UE does not receive DCI indicating the corresponding SSSG switching. For example, the time T that the BS waits for a response from the UE may be considered as (K0min+alpha before change indication). In this case, alpha is a value based on transmission latency and may vary depending on the cell situation.

The BS may determine that the UE does not receive the indication for the change in K0min (or K2min). In addition, the BS may determine that the UE does not receive the SSSG switching indication. The BS may transmit new DCI including a new indication for changing K0min (or K2min) and an indication for SSSG Switching in the SS sets of the previous SSSG or may not transmit the new DCI. The UE may continue the current operation until the UE receives the new DCI. From the perspective of the BS, the new DCI may be the second transmission, while from the perspective of the UE, the new DCI may be the first reception.

According to Method 2, when an indication for a change in K0min (or K2min) is received simultaneously with an indication for SSSG switching and/or PDSCH/PUSCH scheduling, it may not affect PDSCH/PUSCH transmission and reception or SSSG switching. In other words, without any change in the expected PDSCH/PUSCH transmission/reception time and PDCCH monitoring time depending on the time of applying the change in K0min (or K2min) between the BS and UE, the change in K0min (or K2min) may be applied after completing PDSCH/PUSCH transmission and reception as well as PDCCH monitoring based on the current value of K0min (or K2min). Accordingly, from the perspective of the UE, the predictability of the PDSCH/PUSCH scheduling time and the stability of the HARQ retransmission procedure may be improved, thereby stably completing PDSCH/PUSCH transmission and reception and improving power saving efficiency.

In addition, when Method 2 is performed, the method of configuring a plurality of SSSGs for SSSG switching and K0min (or K2min) for each of the plurality of SSSGs may be performed based on Method 1-1 and Method 1-2.

[Method 3] UE Operation Method when SSSG Switching and Cross-Slot Scheduling are Indicated

Method 3 proposes UE operations when the UE is indicated with SSSG switching and cross-slot scheduling. For example, while monitoring SSSG #1, the UE may be instructed to switch to SSSG #0 through scheduling DCI. In addition, the UE may also be instructed to perform cross-slot scheduling for a PDSCH (or PUSCH). The UE may complete decoding of the scheduling DCI up to slot n+K0min (or n+K2min) based on the configured value of K0min (or K2min). Thus, the UE may not check the SSSG switching indication until slot n+K0min (or n+K2min). The time required for DCI decoding may be considered in Y, which is considered as the application delay for the SSSG switching. Additionally, the time required to change a PDCCH monitoring pattern may be included from the perspective of UE implementation.

Therefore, when the SSSG switching and cross-slot scheduling are indicated simultaneously, the time at which the UE completes the SSSG switching may be indicated/configured in consideration of one or more of the following cases.

1) Considering both the time required for the UE to perform the DCI decoding and the time required for the UE to change the PDCCH monitoring pattern, the UE may apply the SSSG switching in slot n+Y+K0min (or n+Y+K2min)−m (where m=0, 1, 2, . . . ). If there is no separate configurations from the BS, m may be set to 0 as the default value. In addition, m may be a value configured by the BS based on the UE capability because the DCI decoding time is considered both in K0min (or K2min) and Y. In other words, since the DCI decoding time is considered when determining K0min (or K2min) and Y, slot n Y+K0min (or n+Y+K2min) may be a value in which the DCI decoding time is considered twice. Therefore, the application delay may excessively delay the application timing, which may hinder fast data transmission. Therefore, by excluding the value of m where the DCI decoding time is considered twice, an appropriate application delay may be determined.

However, even when the application delay is slightly longer because the DCI decoding time is considered twice, if there is not a significant amount of data to transmit or there is no urgent data, there may be no issues with data transmission. Further, it may assist in power saving of the UE, and thus m may be set to 0 or a relatively small value.

2) If the time for the UE to change the PDCCH monitoring pattern is not considered or is capable of being ignored, the UE may perform SSSG switching in slot n+max (K0min (or K2min), Y). If the time for the UE to change the PDCCH monitoring pattern change is not considered or is capable of being ignored, the BS may also indicate/configure the time at which UE needs to complete the SSSG switching.

3) DCI #1 indicating SSSG switching to the UE and DCI #2 indicating cross-slot scheduling may be different. In other words, SSSG switching and cross-slot scheduling may be indicated or configured separately through these two pieces of DCI.

For example, if UE receives DCI #1 in slot n1 and DCI #2 in slot n2, the UE may apply the SSSG switching in slot n1+Y and be scheduled with the PDSCH (or PUSCH) in a slot after slot n2+K0min.

When DCI #1 is intended for power saving and indicates switching from SSSG #0 to SSSG #1, slot n2+K0min (or K2min) may be later in time than the slot n1+Y where the SSSG switching is applied. In other words, even though these indications are given by different DCI, the time at which the cross-slot scheduled PDSCH (or PUSCH) is scheduled may be later in time than the time at which the UE performs the SSSG switching.

However, if the UE performs switching from data-efficient SSSG #0 to SSSG #1 for power saving before receiving the scheduled PDSCH (or PUSCH), the HARQ retransmission procedure may not be executed smoothly. Therefore, in this case, the UE may perform the SSSG switching not in slot n1+Y but in slot n2+K0min (or n2+K2min).

In Method 2 and Method 3, whether the UE operations are performed may be determined based on indications/configurations from the BS, whether or not UE operations are carried out. In addition, whether the operations of Method 2 and Method 3 are performed may be configured based on a field within DCI, a MAC CE, and/or a higher layer parameter. If the operations of Method 2 and Method 3 are configured not to be performed, SSSG switching and cross-slot scheduling may be independently executed without mutual consideration.

For example, if the operations of Method 3 are not configured, SSSG switching may be applied in slot (n1+Y), and PDSCH/PUSCH transmission and reception based on cross-slot scheduling may be performed after slot n2+K0min (or n2+K2min).

While Method 3 has been described with an example of SSSG switching, Method 2 and Method 3 may also be equally applied to PDCCH monitoring skipping. The application delay for the PDCCH monitoring skipping may be set to be the same as or different from that of the SSSG switching, and the application delay (Y) described above may be substituted with the application delay for the PDCCH monitoring skipping.

According to Method 3, when cross-slot scheduling and SSSG switching are indicated through common DCI or different DCI, the application delay for the SSSG switching may be determined in consideration of K0min (or K2min), thereby ensuring stable completion of PDSCH/PUSCH transmission and reception. In addition, when an operation is instructed alone, the application delay may be longer, which may potentially delay the time at which the UE completes DCI decoding, thereby increasing the power saving efficiency of the UE.

Additionally, when Method 3 is executed, the method of configuring a plurality of SSSGs for SSSG switching and the values of K0min (or K2min) for each SSSG may be based on Method 1-1 and Method 1-2.

[Method 4] UE Operation Method when Minimum Applicable Scheduling Offset is not Configured

In Method 1 to Method 3 of the present disclosure, it is assumed that the UE is configured with a minimum applicable scheduling offset. However, Method 4 proposes a method of operating the UE as in Method 1 to Method 3 when the UE is configured with no minimum applicable scheduling offset.

As described above, the UE may receive the values of K0/K2 through the RRC layer as described in [Table 4] extracted from 3GPP TS 38.331. For example, multiple K0/K2 values may be configured to the UE. In addition, the UE may receive one of the multiple K0/K2 values in DCI and determine time-domain resources for a scheduled PDSCH/PUSCH.

Therefore, assuming that minimum non-zero K0/K2 values configurable through the RRC layer are m0/m2, m0/m2 may replace K0min/K2min in Method 1 to Method 3. In other words, if a plurality of K0/K2 values are configured through the RRC layer, the smallest value (i.e., m0/m2) among the plurality of K0/K2 value may replace K0min/K2min in Method 1 to Method 3.

For example, as in Method 1, different m0/m2 values may be configured for each SSSG. The K0/K2 values configurable in PDSCH-TimeDomainResourceAllocationList may be divided and allocated for each SSSG. For instance, PDSCH-TimeDomainResourceAllocationList may be configured once through the RRC layer as in the prior art. However, the row indices for allocation of multiple time resources included in PDSCH-TimeDomainResourceAllocationList may be divided into row indices for SSSG #0 and row indices for SSSG #1. Information on the row indices for SSSG #0 and the row indices for SSSG #1 may be configured to the UE.

Alternatively, PDSCH-TimeDomainResourceAllocationList may be configured for each SSSG. For example, if there are two SSSGs, PDSCH-TimeDomainResourceAllocationLists may be configured twice.

In Method 4, UE operations based on the minimum applicable scheduling offset indicator in DCI is not considered.

Additionally, the UE may perform the operations of Method 2 and Method 3 by replacing K0min/K2min with m0/m2.

According to Method 4, even if K0min/K2min are not configured through the RRC layer, Method 1 to Method 3 may be performed, thereby obtaining the same effect as Method 1 to Method 3.

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

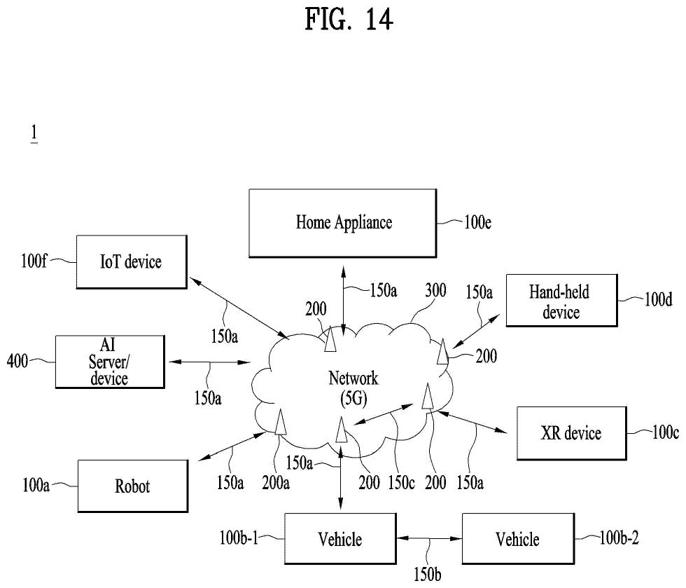

FIG. 14 illustrates a communication system 1 applied to the present disclosure.

Referring to FIG. 14, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

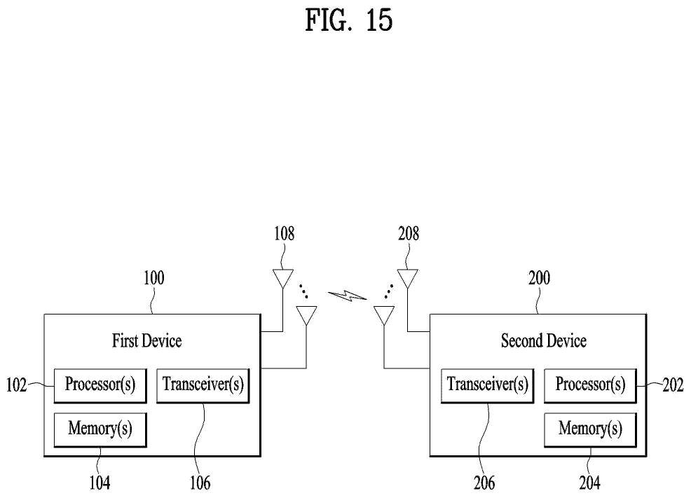

FIG. 15 illustrates wireless devices applicable to the present disclosure.

Referring to FIG. 15, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 14.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor(s) 102 of the first wireless device 100 and stored in the memory(s) 104 of the first wireless device 100, according to an embodiment of the present disclosure will now be described.

Although the following operations will be described based on a control operation of the processor(s) 102 in terms of the processor(s) 102, software code for performing such an operation may be stored in the memory 104. For example, in the present disclosure, the at least one memory(s) 104 may store instructions or programs as a computer-readable storage medium. The instructions or the programs may cause, when executed, at least one processor operably connected to the at least one memory to perform operations according to embodiments or implementations of the present disclosure, related to the following operations.

The processor(s) 102 may transmit capability information and/or UE assistance information to the BS through the transceiver(s) 106 to support the operations proposed in the present disclosure. For example, the capability information and/or UE assistance information may include MinSchedulingOffsetPreference, which is a minimum applicable scheduling offset preferred by the UE, and searchSpaceGroupIdList, which indicates an SSSG including SS sets. However, transmitting, by the processor(s) 102, the capability information and/or UE assistance information through the transceiver(s) 106 may be omitted in specific cases (for example, when the BS already has the information or when each operation method is modified due to the needs of the BS).

The processor(s) 102 may receive first information on cross-slot scheduling and second information on a plurality of SSSGs for SSSG switching, which are transmitted by the BS, through transceiver(s) 106 to support the operations proposed in the present disclosure (S803). In this case, the first information and the second information may be included in common configuration information or different configuration information. For example, the first and second information may be received through the transceiver(s) 106 in a higher layer signal (e.g., SIB or RRC signaling).

Alternatively, the first and second information may also be received through the transceiver(s) 106 based on a method of indicating one of a plurality of configurations related to cross-slot scheduling and SSSG switching that are (semi-)statically provided to the processor(s) 102 through the transceiver(s) 106 (for example, through DCI or a MAC CE/header).

For example, based on the first and second information configured through the higher layer signal, the processor(s) 102 may receive a PDCCH containing DCI indicating a change in one SSSG and a change in K0min/K2min (and/or K0/K2) through the transceiver(s) 106.

Based on the information on cross-slot scheduling and the information on SSSG switching included in the PDCCH, the processor(s) 102 may predict a point in time when the processor(s) 102 is capable of receiving a PDSCH and receive the PDSCH through the transceiver(s) 106 at the time when the reception is allowed.

For example, the above-described operations of the processor(s) 102 may be based on at least one of Method 1 to Method 4.

The processor(s) 102 may transmit capability information and/or UE assistance information to the BS through the transceiver(s) 106 to support the operations proposed in the present disclosure. For example, the capability information and/or UE assistance information may include MinSchedulingOffsetPreference, which is a minimum applicable scheduling offset preferred by the UE, and searchSpaceGroupIdList, which indicates an SSSG including SS sets. However, transmitting, by the processor(s) 102, the capability information and/or UE assistance information through the transceiver(s) 106 may be omitted in specific cases (for example, when the BS already has the information or when each operation method is modified due to the needs of the BS).

The processor(s) 102 may receive first information on cross-slot scheduling and second information on a plurality of SSSGs for SSSG switching, which are transmitted by the BS, through transceiver(s) 106 to support the operations proposed in the present disclosure (S803). In this case, the first information and the second information may be included in common configuration information or different configuration information. For example, the first and second information may be received through the transceiver(s) 106 in a higher layer signal (e.g., SIB or RRC signaling).

Alternatively, the first and second information may also be received through the transceiver(s) 106 based on a method of indicating one of a plurality of configurations related to cross-slot scheduling and SSSG switching that are (semi-)statically provided to the processor(s) 102 through the transceiver(s) 106 (for example, through DCI or a MAC CE/header).

For example, based on the first and second information configured through the higher layer signal, the processor(s) 102 may receive a PDCCH containing DCI indicating a change in one SSSG and a change in K0min/K2min (and/or K0/K2) through the transceiver(s) 106.

Based on the information on cross-slot scheduling and the information on SSSG switching included in the PDCCH, the processor(s) 102 may predict a point in time when the processor(s) 102 is capable of transmitting a PUSCH and transmit the PUSCH through the transceiver(s) 106 at the time when the transmission is allowed (S1107).

For example, the above-described operations of the processor(s) 102 may be based on at least one of Method 1 to Method 4.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor(s) 202 of the second wireless device 200 and stored in the memory(s) 204 of the second wireless device 200, according to an embodiment of the present disclosure will now be described.

Although the following operations will be described based on a control operation of the processor(s) 202 in terms of the processor(s) 202, software code for performing such an operation may be stored in the memory(s) 204. For example, in the present disclosure, the at least one memory(s) 204 may store instructions or programs as a computer-readable storage medium. The instructions or the programs may cause, when executed, at least one processor operably connected to the at least one memory to perform operations according to embodiments or implementations of the present disclosure, related to the following operations.

The processor(s) 202 may receive UE capability information and/or UE assistance information from the UE to support the operations proposed in the present disclosure. For example, the capability information and/or UE assistance information may include MinSchedulingOffsetPreference, which is a minimum applicable scheduling offset preferred by the UE, and searchSpaceGroupIdList, which indicates an SSSG including SS sets. However, receiving, by the processor(s) 202, the UE capability information and/or UE assistance information through the transceiver(s) 206 may be omitted in specific cases (for example, when the processor(s) 202 already has the information or when each operation method is modified due to the needs of the processor(s) 202).

The processor(s) 202 may transmit first information on cross-slot scheduling and second information on a plurality of SSSGs for SSSG switching through the transceiver(s) 206 to support the operations proposed in the present disclosure. In this case, the first information and the second information may be included in common configuration information or different configuration information. For example, the first and second information may be transmitted through the transceiver(s) 206 in a higher layer signal (e.g., SIB or RRC signaling).

Alternatively, the first and second information may also be transmitted through the transceiver(s) 206 based on a method of indicating one of a plurality of configurations related to cross-slot scheduling and SSSG switching that are (semi-)statically provided to the UE (for example, through DCI or a MAC CE/header).

For example, based on the first and second information configured through the higher layer signal, the processor(s) 202 may transmit a PDCCH containing DCI indicating a change in one SSSG and a change in K0min/K2min (and/or K0/K2) through the transceiver(s) 206 (S905)

Based on the information on cross-slot scheduling and the information on SSSG switching included in the PDCCH, the processor(s) 202 may determine a point in time when the processor(s) 202 is capable of transmitting a PDSCH and transmit the PDSCH through the transceiver(s) 206 at the time when the transmission is allowed.

For example, the above-described operations of the processor(s) 202 may be based on at least one of Method 1 to Method 4.

The processor(s) 202 may receive UE capability information and/or UE assistance information from the UE through the transceiver(s) 206 to support the operations proposed in the present disclosure. For example, the capability information and/or UE assistance information may include MinSchedulingOffsetPreference, which is a minimum applicable scheduling offset preferred by the UE, and searchSpaceGroupIdList, which indicates an SSSG including SS sets. However, receiving, by the processor(s) 202, the UE capability information and/or UE assistance information through the transceiver(s) 206 may be omitted in specific cases (for example, when the processor(s) 202 already has the information or when each operation method is modified due to the needs of the processor(s) 202).

The processor(s) 202 may transmit 206 first information on cross-slot scheduling and second information on a plurality of SSSGs for SSSG switching through the transceiver(s) 206 to support the operations proposed in the present disclosure. In this case, the first information and the second information may be included in common configuration information or different configuration information. For example, the first and second information may be transmitted through the transceiver(s) 206 in a higher layer signal (e.g., SIB or RRC signaling).

Alternatively, the first and second information may also be transmitted through the transceiver(s) 206 based on a method of indicating one of a plurality of configurations related to cross-slot scheduling and SSSG switching that are (semi-)statically provided to the UE (for example, through DCI or a MAC CE/header).

For example, based on the first and second information configured through the higher layer signal, the processor(s) 202 may transmit a PDCCH containing DCI indicating a change in one SSSG and a change in K0min/K2min (and/or K0/K2) through the transceiver(s) 206 (S905).

Based on the information on cross-slot scheduling and the information on SSSG switching included in the PDCCH, the processor(s) 202 may determine a point in time when the processor(s) 202 is capable of receiving a PUSCH and receive the PUSCH through the transceiver(s) 206 at the time when the reception is allowed.

For example, the above-described operations of the processor(s) 202 may be based on at least one of Method 1 to Method 4.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

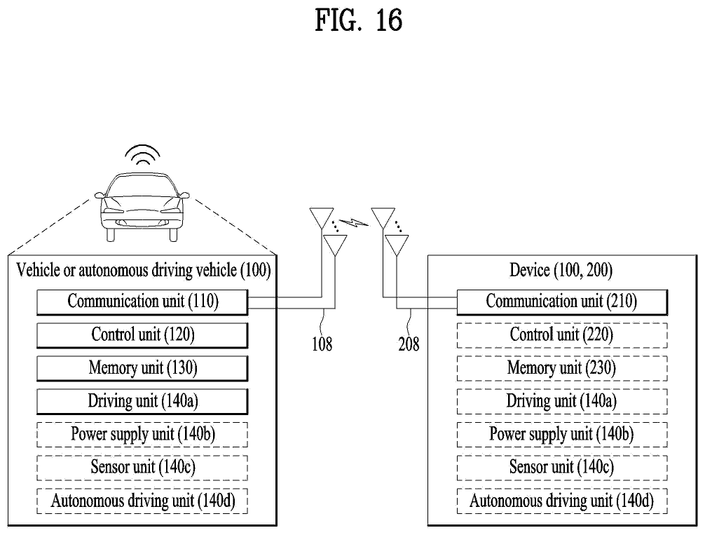

FIG. 16 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 16 a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

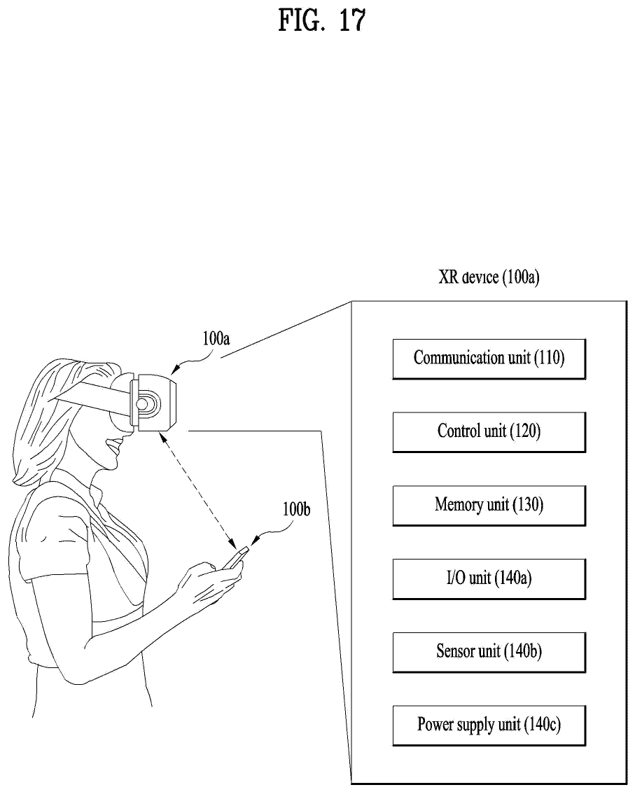

FIG. 17 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 17, an XR device 100a may include a communication unit 110, a control unit 120, a memory unit 130, an I/O unit 140a, a sensor unit 140b, and a power supply unit 140c.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

The embodiments of the present disclosure described herein below are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

While the above-described method of transmitting and receiving a signal in an unlicensed band and an apparatus therefor have been described based on an example applied to a 5G NR system, the method and apparatus are applicable to various wireless communication systems in addition to the 5G NR system.

1. A method of receiving a physical downlink shared channel (PDSCH) by a user equipment (UE) in a wireless communication system, the method comprising:
receiving (i) first information on search space set groups (SSSGs) and (ii) second information on minimum applicable scheduling offsets respectively related to the SSSGs;
receiving downlink control information (DCI) in a specific SSSG among the SSSGs; and
receiving the PDSCH based on the DCI,
wherein the PDSCH is scheduled based on a minimum applicable scheduling offset related to the specific SSSG.

2. The method of claim 1, wherein the PDSCH is scheduled based on a default minimum applicable scheduling offset of the specific SSSG.

3. The method of claim 1, wherein the SSSGs are independently mapped to the minimum applicable scheduling offsets, respectively.

4. The method of claim 1, wherein based on the DCI indicating SSSG switching, an application timing of the SSSG switching is determined based on the minimum applicable scheduling offset and an application delay for the SSSG switching.

5. The method of claim 1, wherein based on the DCI indicating SSSG switching and a change in the minimum applicable scheduling offset, the change in the minimum applicable scheduling offset is applied based on a larger value of a first application delay based on the minimum applicable scheduling offset and a second application delay for the SSSG switching.

6. The method of claim 1, wherein based on that bits for the minimum applicable scheduling offset included in the DCI have a specific value, the minimum applicable scheduling offset is not applied.

7. The method of claim 1, wherein the DCI includes third information on the minimum applicable scheduling offset.

8. A user equipment (UE) configured to receive a physical downlink shared channel (PDSCH) in a wireless communication system, the UE comprising:
at least one transceiver;
at least one processor; and
at least one memory operably connected to the at least one processor and configured to store instructions that, when executed, cause the at least one processor to perform operations comprising:
receiving (i) first information on search space set groups (SSSGs) and (ii) second information on minimum applicable scheduling offsets respectively related to the SSSGs through the at least one transceiver;
receiving downlink control information (DCI) in a specific SSSG among the SSSGs through the at least one transceiver; and
receiving the PDSCH based on the DCI through the at least one transceiver,
wherein the PDSCH is scheduled based on a minimum applicable scheduling offset related to the specific SSSG.

9. The UE of claim 8, wherein the PDSCH is scheduled based on a default minimum applicable scheduling offset of the specific SSSG.

10. The UE of claim 8, wherein the SSSGs are independently mapped to the minimum applicable scheduling offsets, respectively.

11. The UE of claim 8, wherein based on the DCI indicating SSSG switching, an application timing of the SSSG switching is determined based on the minimum applicable scheduling offset and an application delay for the SSSG switching.

12. The UE of claim 8, wherein based on the DCI indicating SSSG switching and a change in the minimum applicable scheduling offset, the change in the minimum applicable scheduling offset is applied based on a larger value of a first application delay based on the minimum applicable scheduling offset and a second application delay for the SSSG switching.

13. The UE of claim 8, wherein based on that bits for the minimum applicable scheduling offset included in the DCI have a specific value, the minimum applicable scheduling offset is not applied.

14. The UE of claim 8, wherein the DCI includes third information on the minimum applicable scheduling offset.

15-17. (canceled)

18. Abase station (BS) configured to transmit a physical downlink shared channel (PDSCH) in a wireless communication system, the BS comprising:
at least one transceiver;
at least one processor; and
at least one memory operably connected to the at least one processor and configured to store instructions that, when executed, cause the at least one processor to perform operations comprising:
transmitting (i) first information on search space set groups (SSSGs) and (ii) second information on minimum applicable scheduling offsets respectively related to the SSSGs through the at least one transceiver;
transmitting downlink control information (DCI) in a specific SSSG among the SSSGs through the at least one transceiver; and
transmitting the PDSCH based on the DCI through the at least one transceiver,
wherein the PDSCH is scheduled based on a minimum applicable scheduling offset related to the specific SSSG.
